(19) United States
(12) Patent Application Publication
(10) Pub. No.: US 2026/0071954 A1
(43) Pub. Date: Mar. 12, 2026

(54) FTIR SPECTROMETER

(71) Applicant: WIREDSENSE GMBH, Hamburg (DE)

(72) Inventors: Matthias BUDDEN, Hamburg (DE); Thomas GEBERT, Elmshorn (DE)

(21) Appl. No.: 19/104,639

(22) PCT Filed: Aug. 14, 2023
(86) PCT No.: PCT/EP2023/072355

§ 371 Date: Feb. 18, 2025

(30) Foreign Application Priority Data
Aug. 19, 2022 (DE) 10 2022 121 038.3

(51) Int. Cl. G01N 21/35; G01J 3/02; G01J 3/453; G01N 21/45; G01N 21/552

(52) U.S. Cl. CPC G01N 21/35; G01J 3/0208; G01J 3/4535; G01N 21/45; G01N 21/552; G01N 2021/3595

(57) ABSTRACT

The present invention relates to an FTIR spectrometer with an infrared radiation source, an interferometer with at least one arm variable in length, a reference laser, a measuring cell with a sample interface, preferably an ATR crystal which can be brought into contact with a sample, an infrared detector, a control system which is configured to change the length of the at least one arm of the interferometer, and a mirror arrangement outside the interferometer with at least two mirrors, each with a reflecting surface and a main body that comprises the reflecting surface, wherein the mirror arrangement is at least configured to direct a light beam from the interferometer onto the sample interface and to direct the light beam from the sample interface to the infrared detector, wherein the main body of at least one mirror or all mirrors of the mirror arrangement is or respectively are made of a plastic material and/or of 3D printed metal, or the main body or the main body of at least one mirror or of all mirrors has or respectively have plastic material and/or 3D printed metal.

The invention relates to an FTIR spectrometer with a mirror consisting of a plastic material. The subject matter of the invention is defined in the appended patent claims.

FTIR (Fourier transform infrared) spectrometers are a special type of spectrometers that can record infrared spectra by means of a special measuring setup. In FTIR spectroscopy, a signal generated by an interferometer is translated into a spectrum by means of Fourier transformation. This spectrum contains information about the measured sample. For example, the chemical composition of foods, materials, chemicals, hazardous materials, medicines and/or plastics can be analyzed non-destructively. Accordingly, FTIR spectrometers are in particular also suitable for the determination and quality control of starting materials for the production of medicines.

For the optical analysis of samples by means of recording spectra, it is generally necessary for the entire employed radiation spectrum, but in particular also in the use of infrared radiation, to produce a very greatest interaction between light and sample material. At the same time, it is desirable to support a wide range of sample types (solids, liquids, powders, etc.). In this regard, in spectroscopy and analytics, the use of so-called ATR crystals (attenuated total reflection) in FTIR spectrometers has proven successful. With the help of an ATR crystal, an evanescent wave can be coupled into the sample material or respectively the sample in contact with the ATR crystal. This effect is also termed the optical tunnel effect. The remaining light carries information about the interaction with the sample, is guided out of the ATR crystal by means of total internal reflection, and can then be guided to an infrared detector, for example by reflection.

In the simplest instance, an FTIR spectrometer comprises a collimated infrared radiation source, an interferometer, a reference laser, a measuring cell with a sample interface which, for example, comprises an ATR crystal as well as an infrared detector and a control system.

The interferometer comprises a beam splitter that splits incident light into two individual beams. The individual beams are each reflected at one (or possibly multiple) mirror(s) of the interferometer and then recombined in the beam splitter, wherein they interfere with each other. The path of an individual beam in the interferometer from the beam splitter to the (last) reflecting mirror and back, or respectively the assembly linked to this path in the interferometer, is usually designated an arm. One of the arms of the interferometer or both arms of the interferometer are usually variable in length. This is practically implemented by moving at least one mirror of one or both arms relative to the beam splitter. The length of the arm or respectively the arms (and therefore the mirror movement or respectively mirror movements) is or respectively are controlled by the control system. This allows the interference of the reflected individual beams to be changed or respectively adjusted. With the help of the reference laser, the lengths of the arms or respectively the distances traversed by the individual beams in the arm and/or the difference in distance in the interferometer are determined.

For example, the control system can regulate a mirror offset of a mirror of one of the two arms of the interferometer movable along a linear axis. This changes the distance of the movable mirror from the beam splitter in the arm and therefore the distance to be traversed by the light, also termed the path length, in the arm.

Alternatively, an interferometer with a rocker rotatable in a plane is known in the prior art. The rocker is designed in such a way that it comprises, in particular, the mirrors of the interferometer necessary for the reflection of both individual beams coming from the beam splitter. The rocker therefore forms both arms of the interferometer. The control system regulates a rotary movement of the rocker in such a way that the rocker executes a pendulum movement between two end points relative to the stationary beam splitter. In the pendulum movement, one arm is alternately shortened relative to the beam splitter with the simultaneous lengthening of the other arm of the interferometer. In this case, the path lengths of both arms to be traversed by the light are therefore changed. This also allows the interference of the reflected individual beams to be adjusted.

The intensity of the light beam arising after the interference of the individual beams is measured by the infrared detector, for example after passing through the measuring cell with the sample interface. The absorption spectrum of the sample can then be calculated from the intensity measured in the infrared detector and the path length in the interferometer determined with the reference laser. This provides conclusions about the type, composition and condition of the sample, and therefore represents a kind of chemical fingerprint of the sample or respectively the sample material.

In particular with the use of ATR crystals in FTIR spectrometers, a good signal-to-noise ratio (SNR) is decisive for an informative measurement with high measurement speed and the sensitivity of the measurement needed for an informative spectrum. The SNR is largely determined by the amount of light coupled into the ATR crystal over a maximum possible wavelength range.

Light is typically coupled into the ATR crystal through technically complex and cost-intensive optical assemblies. For example, beam splitters are used in the prior art which typically have high losses of more than 50% of the irradiated light from passing twice through the beam splitter. Alternative approaches to maximizing the sample signal from ATR crystals provide multiple reflection within the ATR crystal. For this purpose, in comparison to single-reflection ATR FTIR spectrometers, comparatively large ATR crystals are needed. Large ATR crystals are, however, associated with a high production effort as well as high production costs for the manufacturing the ATR crystals. Moreover, the employed material such as diamond is often very expensive. Other solutions use laboriously coated refractive optical systems, fiber optical systems or Schwarzschild lenses which are involved, complex and expensive in production or time-consuming in the adjustment of the optical system, or even do not transmit the light from a broadband light or infrared source independent of wavelength.

Moreover, the FTIR spectrometers available in the prior art usually comprise technically complex and expensive optical elements, in particular mirrors. A typical example of mirrors used with the aforementioned disadvantages are metal precision mirrors. Metal precision mirrors are typically milled from a solid metal block by means of complex CNC milling work. The milling tools of a CNC machine used in the milling process are highly stressed and worn during this type of production. Moreover, this type of mirror production is very resource-intensive due to the required very fine adjustment of the chip removal during the CNC milling process in order to obtain the desired mirror shape without grooves or scores with optical surface roughness. The use of such mirrors therefore leads to a substantial cost increase in the overall assembly of an FTIR spectrometer available in the prior art due to the complex manufacturing process, which does not become more economical even with large quantities. Alternative, technically easier to produce mirror variants for use in FTIR spectrometers are not available in the prior art. A metal precision mirror or precision metal mirror is therefore a mirror known in the prior art with a high manufacturing effort and therefore high price, which at the same time has outstandingly advantageous optical properties. A metal precision mirror is an example of a precision mirror, i.e. for an optical system with a high optical quality. As a rule, metal precision mirrors are without alternative in the construction of high-precision known interferometers in known FTIR spectrometers.

The consequence of using the aforementioned optical elements is a generally high technical manufacturing effort of an FTIR spectrometer as well as high acquisition costs, even for “entry-level” FTIR spectrometers. Due to the wide bandwidth of possible uses, simplification of the manufacturing effort of the optical assembly and a reduction of the manufacturing costs and therefore also the acquisition costs is particularly desirable. Moreover, a more sustainable production of at least a part of the optical components is desirable. By eliminating these disadvantages, FTIR spectrometers for optical analysis are consequently made accessible to companies, state authorities, schools and universities, start-ups, doctors and pharmacists as well as private individuals with a limited budget.

The object of the present invention is therefore the provision of an easier to produce, reliable, more economical and more sustainable FTIR spectrometer with a simplified optical assembly that eliminates the disadvantages of the prior art.

The object is achieved by the FTIR spectrometer described in claim 1. Preferred embodiments according to the invention result from the dependent claims and the following explanations.

The object is achieved by an FTIR spectrometer according to claim 1. The FTIR spectrometer according to the invention comprises an infrared radiation source, an interferometer with at least one arm variable in length, a reference laser, a measuring cell with a sample interface, preferably an ATR crystal which can be brought into contact with a sample, an infrared detector, a control system which is configured to change the length of the at least one arm of the interferometer, and a mirror arrangement outside the interferometer with at least two mirrors, each with a reflecting surface and a main body that comprises the reflecting surface, wherein the mirror arrangement is at least configured to direct a light beam from the interferometer onto the sample interface and to direct the light beam from the sample interface to the infrared detector, wherein the main body of at least one mirror or all mirrors of the mirror arrangement is or respectively are made of a plastic material and/or of 3D printed metal, or the main body or the main body of at least one mirror or of all mirrors has or respectively have plastic material and/or 3D printed metal.

The object is achieved in particular by the following FTIR spectrometer according to the invention, the FTIR spectrometer according to the invention comprises an infrared radiation source, an interferometer with at least one arm variable in length, a reference laser, a measuring cell with a sample interface, preferably an ATR crystal which can be brought into contact with a sample, an infrared detector, a control system which is configured to change the length of the at least one arm of the interferometer, and a mirror arrangement outside the interferometer with at least two mirrors, each with a reflecting surface and a main body that comprises the reflecting surface, wherein the mirror arrangement outside the interferometer is at least configured to direct a light beam from the interferometer onto the sample interface and to direct the light beam from the sample interface to the infrared detector, wherein the main body of at least one mirror of the mirror arrangement outside the interferometer or all mirrors of the mirror arrangement outside the interferometer is or respectively are made of a plastic material and/or of 3D printed metal, or the main body or the main body of at least one mirror of the mirror arrangement outside the interferometer or of all mirrors of the mirror arrangement outside the interferometer has or respectively have plastic material and/or 3D printed metal.

The core of the invention relates to the surprising discovery that the precision mirrors used in the prior art outside the interferometer, such as metal precision mirrors or precision mirrors consisting of other materials, can be partially or completely replaced by the mirrors of the mirror arrangement according to the invention. Expressed otherwise, the surprising discovery is that optical systems with a high quality must be used within the interferometer of the FTIR spectrometer in order to obtain the necessary signal quality or respectively constructive interference. Examples of such optical systems are the known precision mirrors already described above, such as metal precision mirrors. However, precision mirrors consisting of other materials are also conceivable.

Outside the interferometer of the FTIR spectrometer, however, it is surprisingly sufficient if optical systems with a low optical quality or lower optical quality than conventional precision mirrors are used. These optical systems with low optical quality or lower optical quality than precision mirrors can in particular have a high wavefront error. These optical systems with low or lower optical quality outside the interferometer correspond to the mirrors of the mirror arrangement outside the interferometer of the FTIR spectrometer according to the invention described in the context of this invention.

Within the meaning of the invention, an optical system with a high optical quality describes an optical system, in particular a mirror or a mirror arrangement, in which the wavefront error is much smaller than a wavelength of the reflected light. It is known to a person skilled in the art from optical contexts regarding the interference of light waves that the wavefront error of the mirrors within the interferometer of FTIR spectrometers must be significantly smaller than a wavelength in order to obtain constructive interference with usable intensity. Therefore, the use of optical systems with a high optical quality is required within the interferometer of FTIR spectrometers.

Within the meaning of the invention, an optical system with a low optical quality describes an optical system, in particular a mirror or a mirror arrangement, in which the wavefront error is larger, preferably much larger than a wavelength of the reflected light. Such optical systems with low quality allow no and just a slight constructive interference with useful intensity. Therefore, such optical systems with low optical quality are not suitable for use in interferometers of FTIR spectrometers. Surprisingly, however, optical systems with low optical quality are suitable for use outside the interferometer of an FTIR spectrometer since the wavelength error surprisingly has less influence on the measured intensity there.

The advantage of this surprising discovery is that the manufacturing process of an FTIR spectrometer is thereby greatly simplified with nearly the same measurement quality. Moreover, the costs and resources of an FTIR spectrometer necessary for production are greatly reduced with virtually the same measurement quality. Further advantages are described below.

The terms “light” and “light beam” or respectively “light rays” are used synonymously in the context of this invention and describe electromagnetic radiation, preferably in the infrared and/or optical wavelength range, which follow a beam path. In the context of this invention, a beam path describes a trajectory of the light or the light beams through or along optical elements and components in the FTIR spectrometer according to the invention, in particular the mirrors of the mirror arrangement of the FTIR spectrometer described in the context of this invention.

The infrared radiation source can, for example, emit at least light in the wavelength range of near and/or mid-infrared. For example, the infrared radiation source can emit at least light in the wavelength range from 1 μm to 50 μm. However, it is also conceivable that the infrared radiation source also emits light in the visible spectrum. The infrared radiation source can, for example, be a heated element consisting of silicon carbide which can be heated to a temperature in the range of around 1200 K. It is also conceivable that the infrared radiation source is a tungsten halogen lamp, a mercury discharge lamp, or a plasma light source. The infrared radiation source can be spatially extended, for example in at least one spatial direction in the range of up to 30 mm.

The light generated by such an infrared radiation source extended in this way can be collimated by suitable optical means before entry into the interferometer. In this context, the following components or assemblies are examples of suitable means: Lenses and/or mirrors or mirror assemblies, e.g. comprising parabolic mirrors, off-center parabolic mirrors which are also termed off-axis parabolic mirrors, and/or so-called known compound parabolic concentrator mirrors (CPC). Preferably, the light emitted by the infrared radiation source is collimated by means of a parabolic mirror, an off-axis parabolic mirror, or a CPC. Such mirrors have the advantage that they collimate the incident light particularly efficiently. Moreover, losses of the reflected light due to absorption or dispersion, as would otherwise occur with transmissive optical elements such as lenses, can be advantageously avoided. This can significantly improve the signal-to-noise ratio (SNR).

Within the interferometer of the FTIR spectrometer according to the invention, the quality of the optical systems is critical since any errors on the scale of fractions of a wavelength lead directly to the destruction of the interference and therefore to signal loss. Accordingly, the interferometer preferably comprises exclusively planar mirrors as well as a beam splitter with a planarity in the range of a fraction of the wavelengths to be measured.

Preferably, the beam splitter has the same material as a window of the infrared detector or is produced from this material. Consequently, only one source is introduced into the FTIR spectrometer instead of two different sources for dispersion and absorption. Ultimately, this significantly improves the signal that reaches the detector. KBr, Csl, ZnSe, diamond, KRS-5, Ge, Si are particularly preferred as materials for the window of the infrared detector and the beam splitter. These materials are very broadband with regard to the transmission of infrared radiation, whereby the are well suited for simultaneous use in a beam splitter and a window of an infrared detector.

The interferometer comprises a beam splitter that splits incident light into two individual beams. The path of an individual beam in the interferometer from the beam splitter, for example along one or more mirrors, to the corresponding mirror at which the individual beam is reflected back to the beam splitter or the assembly associated with this path in the interferometer is designated an “arm” within the meaning of the invention. The individual beams are each reflected at one mirror or several mirrors of the arms in the interferometer back to the beam splitter and recombined in the beam splitter, wherein they interfere with each other. One of the arms of the interferometer or both arms of the interferometer are variable in length. This can be implemented, for example, by a movement of at least one mirror of one or both arms relative to the beam splitter. The length of the arm or the arms (and therefore the mirror movement or mirror movements) can be regulated by the control system. This allows the interference of the reflected individual beams to be changed or respectively adjusted.

For example, the control system can regulate a mirror offset of a mirror of a first of two arms of the interferometer movable along a linear axis. This changes the distance of the movable mirror from the beam splitter in the first arm and therefore the distance to be traversed by the light, also termed the path length, in the first arm.

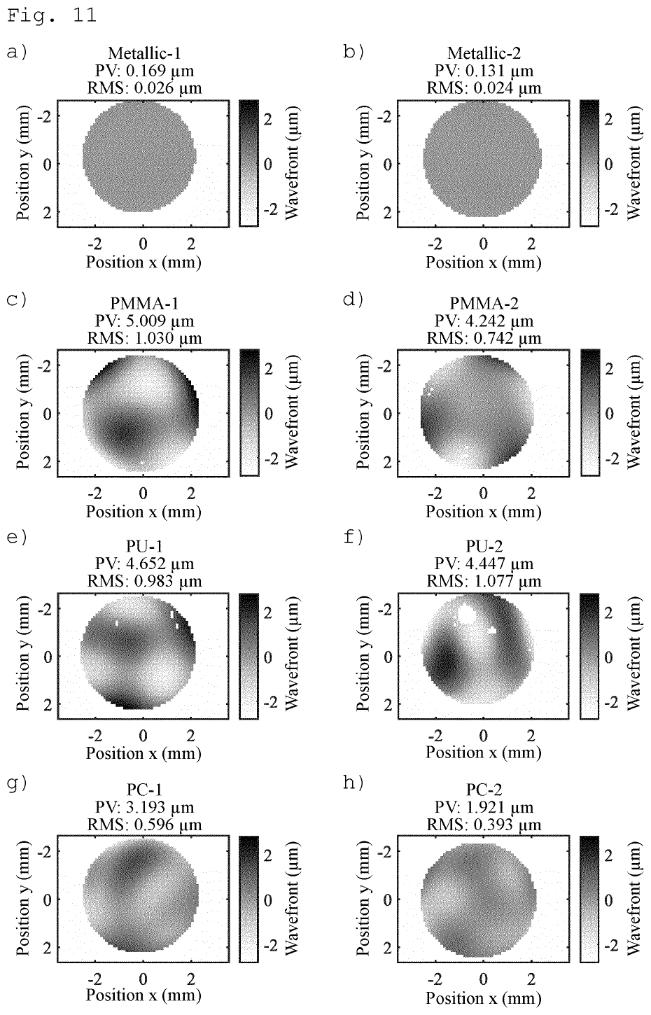

Alternatively, the interferometer can comprise a rocker which is rotatably mounted in a plane relative to the stationary beam splitter. The rocker is designed in such a way that it comprises, in particular, the mirrors of the interferometer necessary for the reflection of both individual beams coming from the beam splitter. The rocker therefore forms the first and second arm of the interferometer. For example, the rocker can be designed as shown in J. Kauppinen et al, Appl. Spectrosc. Rev. 39, 99 (2004), FIG. 20. The control system regulates a rotary movement, for example with the help of a drive of the rocker, in such a way that the rocker executes a pendulum movement between two end points relative to the stationary beam splitter. In the pendulum movement, one arm is alternately shortened relative to the beam splitter with the simultaneous lengthening of the other arm of the interferometer. In this case, the path lengths of both arms to be traversed by the light are therefore changed. This also allows the interference of the reflected individual beams to be adjusted.

The rotatable rocker can, for example, be rotatably mounted nearly friction-free via a solid joint or a roller bearing, for example a ball or roller bearing. The rotatable rocker can be stimulated to rotate by the drive. The drive can be or comprise a voice coil, for example. The voice coil has the advantage that it has no or only a few mechanical parts compared to typical electric motors and/or drives and therefore introduces no or only slight undesirable additional mechanical disturbances into the interferometer during operation. Moreover, such a drive is durable and robust.

Alternatively, the interferometer can also be any other suitable interferometer in which the path length difference within one or both arms can be changed during a measurement.

The two individual beams interfere with each other depending on the path length difference which arises from the movement of the movable mirror or respectively both movable mirrors in the interferometer. As a consequence, a strong constructive maximum (center burst) with flat wings arises in the wavelength range in which the mirrors are equidistant from the beam splitter.

Preferably, one or both mirrors in the interferometer are each held by a mirror holder described below.

The mirror holder can have a main body that can be connected to a section of the interferometer or the FTIR spectrometer, e.g. a housing section.

The mirror holder can also have a first part. The first part can be connected to the main body.

The first part can have a first spring steel sheet or be formed therefrom. In the first case, the main body can be connected to the first part by means of the first spring steel sheet. Spring steel sheets are economical, easy to machine, and have particularly advantageous spring properties.

In this case, the first part can be designed plate-like. Plate-like components are easy to produce.

The mirror holder can comprise a first screw rotatably mounted in the main body, which distances the first part from the main body against a spring force of the first spring steel sheet. The first screw can then only have a force-fit connection with the first part.

The first spring steel sheet can exert a spring force so that the first part is pretensioned in the direction of the main body, and the first screw, or respectively an end of the first screw facing the first part, forms an abutment for the spring force of the first part.

A mirror can be accommodated or provided on the first part.

Such a mirror holder comprising a main body and a first part has the advantage that a distance between the main body and the first part can be set almost hysteresis-free in a screwing-in or screwing-out movement of the first screw due to the work against the spring tension by the first spring steel plate. The change in this distance in turn results in an angular change between the main body and the first part in a corresponding arrangement of the first screw. Therefore, a first angular change without hysteresis can be made using the mirror holder, which is particularly advantageous for mirror adjustment.

The force-fit connection of the screw end of the first screw can, for example, be made directly to the first spring steel sheet of the first part or a separate material.

The separate material can preferably be abrasion-resistant and withstand the forces that the screw end of the first screw exerts on the first part from the force-fit connection, in particular during frequent rotational movements. This can extend the service life of the mirror holder.

The mirror holder can preferably have a second part, wherein the second part can be connected to the first part. The second part can have a second spring steel sheet or be formed therefrom. In the first case, the second part can be connected to the first part by means of the second spring steel sheet.

The second part can in this case be designed plate-like.

A second screw rotatably mounted in the main body can distance the second part from the first part and/or from the main body. The second screw can only have a force-fit connection with the second part. The second spring steel plate can exert a spring force in such a way that the second part is pretensioned in the direction of the first part, and the second screw or respectively an end of the second screw facing the second part, forms an abutment for the spring force of the first part. In this case, the mirror can be accommodated or provided on the second part.

Such a mirror holder comprising a main body and a first and an additional part has, in comparison to the above-described assembly consisting of the main body and only the first part, the additional advantage that a distance between the second part and the first part can be set almost hysteresis-free in a screwing-in or screwing-out movement of the second screw due to the work against the spring tension by the second spring steel plate. The change in this distance in turn results in an angular change between the second part and the first part in a corresponding arrangement of the second screw. Therefore, another second angular change in a different direction from the first angular change without hysteresis can be made using the mirror holder, which is particularly advantageous for mirror adjustment. Moreover, the assembly is easy to realize in production since only simple components are used.

The first part and the second part can preferably be arranged substantially parallel to each other in an initial state. This allows the initial state to be easily defined.

The first and/or second part can preferably have a cuboid shape. Such shapes are easy to produce.

The second spring steel sheet can preferably be arranged on one of the side surfaces of the second part, which is perpendicular or transverse to the surface that accommodates or provides the mirror. This enables simple mounting or fastening of the second spring steel plate.

The first spring steel sheet can preferably be arranged on one of the side surfaces of the first part, which is perpendicular or transverse to the surface that accommodates or provides the mirror. In this case, the first spring steel sheet can additionally be arranged non-parallel to the second spring steel sheet. Expressed otherwise, in this case, the surface normals of the first and second spring steel sheets can be orthogonal and nearly orthogonal to each other. This enables simple mounting or fastening of the second spring steel plate. Moreover, this has the advantage that an adjustment can be made in two spatial directions (nearly) perpendicular to each other. Expressed otherwise, this allows the first and second angular changes to be decoupled from each other. This significantly simplifies the adjustment of the mirror encompassed by the described mirror holder.

The reference laser has a known wavelength and is preferably actively current-stabilized and/or temperature-stabilized. For example, the reference laser can be a helium-neon laser. Alternatively, the reference laser can be an economical and easy-to-obtain diode laser. In addition to the reference laser, a reference interferometer can also be provided. Such a reference interferometer serves to determine the position of the length change in the interferometer and is not another FTIR interferometer for reference and calibration purposes. That which is stated below applies analogously to the reference interferometer. With the help of the reference laser, the position and a tilt angle of a mirror of one arm or the mirrors of both arms of the interferometer can be determined, or a relative path length difference between the mirrors of the first and second arm of the interferometer can be determined. In this context, the tilt angle can describe an angle between the mirror of one arm or respectively between a surface normal of the mirror and, for example, the incident reference laser beam. The reference laser can, for example, emit light in the red, green or orange range. Typical wavelengths lie in the range of visible light from 730 nm to 543 nm.

The reference laser can alternatively or additionally emit light in the infrared range, preferably in the range from 900 nm to 1100 nm, particularly preferably in the range from 960 to 1000 nm, e.g. 980 nm. This has the advantage that the advantages of optical systems optimized for the reflection of infrared radiation can be exploited in the FITR spectrometer according to the invention. Moreover, from the use of infrared light in the reference laser, the interference signal is easier to measure due to the longer wavelength of the infrared light in comparison to light from the visible range. In comparison to light from the visible range, the longer wavelength results in a slower movement of the interference pattern during a movement of the arm or arms of the interferometer. This reduces the requirements on the measuring speed of the infrared detector or respectively the control system. In particular, this reduces the requirements on an analog-digital converter of the microcontroller or on the microcontroller itself.

The reference laser can emit particularly preferably in the range from 960 to 1000 nm, e.g. 980 nm. Preferably, the reference laser with a wavelength in the range from 960 to 1000 nm, e.g. 980 nm, is a diode laser. This wavelength range, in particular the wavelength 980 nm, represents an optimal compromise between the precision of the determination of the above-mentioned parameters and the necessary measuring speed of the infrared detector or respectively an analog-to-digital converter connected thereto. Moreover, diode lasers are particularly economical and easy to produce.

Alternatively, the reference laser can preferably emit in the range from 600 nm to 1600 nm. Reference lasers, in particular diode lasers which emit in this range are particularly easy to produce and economical.

Preferably, the wavelength of the reference laser can be varied by means of a variation of the temperature of the reference laser so that known absorption lines of gas molecules, preferably of oxygen inside or outside the FTIR spectrometer according to the invention, are exceeded during the variation of the wavelength. In this case, the reference laser is preferably a diode laser. Particularly preferably, this reference laser emits in the range from 600 nm to 1600 nm.

It is also conceivable that the wavelength of the reference laser is varied by means of a variation of the temperature of the reference laser in such a way that known absorption lines of gas molecules, preferably of oxygen, are exceeded inside or outside FTIR spectrometers or other FTIR spectrometers known in the prior art during the variation of the wavelength. In this case as well, the reference laser is preferably a diode laser. Particularly preferably, this reference laser emits in the range from 600 nm to 1600 nm.

A corresponding calibration method of the FTIR spectrometer according to the invention or of FTIR spectrometers known in the prior art or other FTIR spectrometers can preferably comprise the following steps:
1. Varying the temperature of the reference laser, which is preferably a diode laser, in such a way that the wavelength of the reference laser changes, wherein the measurement is carried out without a sample in the measuring cell,
2. Measuring a signal, preferably an intensity, of the reference laser by the infrared detector,
3. Preferably regulating the temperature of the reference laser so that the measured signal of a known absorption line, preferably of a gas, particularly preferably of oxygen, is maximized.

Alternatively to a variation of the temperature of the diode laser or in addition to a variation of the temperature of the diode laser, the current of the diode laser can also be controlled analogously to steps 1 and 3 of the aforementioned calibration method. Alternatively to a variation of the temperature of the diode laser or in addition to a variation of the temperature of the diode laser, the current of the diode laser can also be controlled analogously to steps 1 or 3 of the aforementioned calibration method.

Particularly preferably, the calibration method can be carried out automatically, for example by the control system of the FTIR spectrometer according to the invention. The automatic calibration can occur at regular time intervals or at irregular time intervals. The automatic calibration can be carried out before a measurement and/or as a step during a measurement sequence.

It is also conceivable for the calibration method to be carried out automatically, for example by the control system of FTIR spectrometers known in the prior art or other FTIR spectrometers. The automatic calibration can occur at regular time intervals or at irregular time intervals. The automatic calibration can be carried out before a measurement and/or as a step during a measurement sequence.

Oxygen has an absorption line at around 850 nm. Therefore, oxygen is optimally suitable for calibrating the wavelength of the reference laser.

The calibration method represents a fast, error-proof and robust option for absolute wavelength calibration. Moreover, the type of above-described calibration of the wavelength has the advantage that calibration with additional samples, such as for example a polystyrene film, can be avoided. This is particularly advantageous in the determination of the quality of a sample using pharmaceutical substances, such as for example can be carried out in pharmacies or by pharmacists, since with the aforementioned calibration method, a sufficient resolution of an FTIR spectrometer, preferably the FTIR spectrometer according to the invention, can be demonstrated.

The light guided from the interferometer and directed to the measuring cell interacts with the sample material in the measuring cell or respectively on and/or in the sample interface enclosed therein. The sample interface provides an interface at which the infrared light can be coupled into and out of the sample. For example, the sample interface can be or have fiber optical system. Alternatively, the sample interface can also be a device that enables measurement by means of diffuse reflectance infrared Fourier transform spectroscopy (DRIFTS for short). Alternatively, the sample interface can also be a device that enables the recording of infrared spectra in the transmission method. Preferably, the light is coupled as a free beam into the sample interface. Particularly preferably, the light is coupled as a free beam into the sample interface after upstream focusing by means of a parabolic mirror or an off-axis parabolic mirror.

Preferably, the sample interface is an ATR crystal. The ATR crystal can, for example, consist of ZnSe, Ge, thallium bromide iodide (KRS-5), Si, AMTIR (amorphous material transmitting infrared radiation, e.g. GeAsSe=AMTIR-1) or diamond. In this case, the ATR crystal can have a surface that can be brought into contact with the sample or a sample material. For example, a sample can be pressed onto the surface of the ATR crystal by suitable means. One possible suitable means can be a clamping or screwing device that applies pressure to the sample.

The infrared detector has a sensitivity in the wavelength range in which the infrared spectra are to be measured. The sensitivity of the infrared detector can, for example, be in the entire range from 1 μm to greater than 50 μm, or in one or more of the following subranges: 1 to 2.5 μm (near infrared), 2 to 25 μm (mid infrared) or greater than 50 μm (far infrared). Preferably, the infrared detector has a sensitivity that lies in the near and mid infrared range, i.e. in the range from 1 μm to 25 μm.

The infrared detector can be or have a photodiode, for example.

Preferably, the infrared detector can be a pyroelectric sensor or have a pyroelectric sensor. In addition, the infrared detector can have a window consisting of a material permeable to infrared radiation. Suitable materials have already been mentioned above in connection with the material selection of the window of the infrared detector and the beam splitter of the interferometer. In the context of this invention, a pyroelectric sensor is a component in which, as a result of its pyroelectric properties, a temperature difference causes a change in the electrical voltage of the component. Pyroelectric sensors have the advantage that they have a large optical detection bandwidth during measurement. Expressed otherwise, pyroelectric sensors have the advantage that they can measure a large wavelength range in comparison to other known sensors.

The control system which is configured to change the length of the at least one arm, e.g. the first and/or the second arm, of the interferometer, can be designed in various ways. For example, the control system can be or comprise a microprocessor, microcontroller or a computer. The control system can, for example, be configured to actuate one or more electromechanical control elements, for example an electric motor or a voice coil, or one or more piezoelectric control elements. In this case, the one control element or respectively several control elements can be coupled to the at least one arm or respectively both arms, and/or the mirrors enclosed therein in such a way that the length of one arm or both arms can be changed upon the actuation of a control element.

It is alternatively conceivable that the control system is or comprises an electronic or electrical circuit that actuates the aforementioned control elements. For example, the control system can only provide a periodically changing voltage, for example an alternating voltage which causes the electric motor or the voice coil and therefore the rotatable rocker to perform the oscillating movement. Alternatively, the control system can provide a DC voltage or another voltage that is switched on and off periodically or irregularly and accordingly causes the electric motor or the voice coil and therefore the rotatable rocker to perform the oscillating movement.

The control system can be configured to control the length of the at least one arm, e.g. the first and/or the second arm, or the control elements autonomously, i.e. without additional external control signals from outside the interferometer or the FTIR spectrometer according to the invention. Alternatively, the control system can be configured to control the length of the at least one arm, e.g. the first and/or the second arm, or the control elements depending or in reaction to external control signals from outside the interferometer or the FTIR spectrometer. In the context of this invention, an actuation or control of the movement of the movable mirrors can describe the following: Switching the aforementioned control elements on, off or over, controlling the movement of the at least one arm or both arms by means of the aforementioned control elements with a closed or open loop control known in the prior art, or any other suitable method by which one or more of the aforementioned control elements changes the length of at least one arm of the interferometer in its length in a desired manner. In addition, the control system can be designed and configured to control the infrared detector, and/or to control and/or perform the data acquisition.

Within the meaning of the invention, the term “mirror arrangement” is understood as the assembly of those mirrors within the FTIR spectrometer according to the invention which are not included in the assembly of the interferometer of the FTIR spectrometer. Expressed otherwise, within the meaning of this invention, the mirror arrangement of the FTIR spectrometer comprises all mirrors within the FTIR spectrometer outside the interferometer. Expressed otherwise, the mirrors described in the context of the invention (sometimes termed “mirrors according to the invention”) relate exclusively to at least one mirror outside the interferometer of the FTIR spectrometer. The mirrors inside the interferometer of the FTIR spectrometer are not the subject of this invention. Within the meaning of the invention, directing or also alternatively guiding the light, for example from the interferometer onto the sample interface and further to the infrared detector, comprises reflection of the light and optionally beam shaping of the light beam. The directing can preferably be carried out by means of the reflecting surfaces of the mirrors described in the context of the invention. Beam shaping can comprise, for example, focusing, collimating or any other advantageous change of the light beam.

The mirror arrangement outside the interferometer comprises at least two mirrors, each with a reflecting surface, and a main body that comprises the reflecting surface, wherein the mirror arrangement is configured at least to direct a light beam from the interferometer onto the sample interface and to direct the light beam from the sample interface onto the infrared detector. Preferably, the mirror arrangement outside the interferometer can comprise at least two mirrors, each with a reflecting surface and a main body that comprise the reflecting surface, wherein the mirror arrangement is configured to at least direct a light beam from the infrared radiation source onto the interferometer and/or from the interferometer onto the sample interface, and to direct the light beam from the sample interface onto the infrared detector. The reflecting surface of one of the at least two or all mirrors is preferably designed sectionally concave or as a concave mirror. In the context of this invention, the main body of a mirror is any assembly or body which comprises or holds the reflecting surface or to which the reflecting surface is sectionally applied directly or indirectly, e.g. via intermediate layers, and therefore makes the reflecting surface connectable to other parts of the FTIR spectrometer according to the invention via the main body. For example, if the reflecting surface is or comprises a metal coating, the reflecting surface can be applied directly to a section of the surface of the main body. Alternatively, the metal coating can be applied to intermediate layers. The intermediate layers (or at least one of them) can in turn be applied directly to the section of the surface of the main body.

The main body can, at least sectionally, have block-like sections or consist completely of one or more block-like sections. Block-like means in this context that it is not plate-like. A section is plate-like if it is designed thin in a plane or in a curved surface. Block-like sections can, for example, be built according to one or more of the following basic geometric shapes: cuboid, cube, cylinder, pyramid, cone, sphere.

The following parts are not part of the main body within the meaning of the invention: partial or complete outer coatings of the main body, e.g. paints, varnishes, powder coatings, protective coatings, and/or other coatings. The following parts are also not part of the main body within the meaning of the invention: devices which are provided for a user for the operation, holding or mounting of the mirror with the main body and/or have a decorative function. The following parts are also not part of the main body within the meaning of the invention: partial or complete coatings of the reflecting surface which, for example, provide a protective function for the reflecting surface and/or influence the optical properties of the reflecting surface.

The main body can be designed as a single piece together with the reflecting surface. In this case, the reflecting surface can be applied directly to a surface section of the main body. For example, the reflecting surface can be applied directly to a block-like section of the main body. Alternatively, it is also conceivable for the reflecting surface to be applied indirectly, i.e. for example on an intermediate layer on the surface section of for example the block-like main body. The main body can, for example, be connectable to a part, e.g. a part of a housing or a base plate of the FTIR interferometer according to the invention or, more correctly, of the FTIR spectrometer according to the invention.

Alternatively to the one-piece design, the main body can be designed in several pieces with at least a first and a second part (and possibly other parts such as spacers or the like). In this context, it is conceivable, for example, for the first part of the main body to comprise the reflecting surface directly on a surface section, as in the one-piece case, or comprise the reflecting surface indirectly via an intermediate layer. For example, a block-like section of the main body can comprise the intermediate layer and the reflecting surface thereon. The first part of the main body can then be connectable with the second part of the main body (and possibly further parts of the main body) to a part of the housing or the base plate of the FTIR interferometer according to the invention or, more correctly, of the FTIR spectrometer according to the invention.

According to the invention, the main body of at least one mirror or all the mirrors of the mirror arrangement are made of a plastic material. Alternatively, according to the invention the main body of at least one mirror or all the mirrors of the mirror arrangement has plastic material. Alternatively, the main body of at least one mirror or of all mirrors of the mirror arrangement is made of 3D-printed metal according to the invention. Alternatively, the main body of at least one mirror or all mirrors of the mirror arrangement has 3D-printed metal according to the invention. In particular, one or all mirrors of the mirror arrangement can be made of or have at least partially a plastic material.

Within the meaning of the invention, a plastic material describes a thermoplastic, in particular a semi-crystalline thermoplastic or an amorphous thermoplastic. Preferably, the plastic material is a semi-crystalline or amorphous thermoplastic. Semi-crystalline and amorphous thermoplastics have the advantage that they are easy to process, widely available and economical. Alternatively, the plastic material can also be a thermoset.

Within the meaning of this invention, a 3D printing method for metal comprises any 3D printing method known and suitable in the prior art for printing metal. An example of a suitable material for 3D printing from metal is stainless steel, aluminum or titanium. Preferably, the 3D printing method from metal has a print resolution per layer of a maximum 230 μm. In combination with an optional subsequent polishing step, a smooth surface can be provided on the 3D-printed material with a high quality. Particularly preferably, the 3D printing method for metal has a maximum print resolution of 30 μm per layer. A preferred material for 3D printing is stainless steel.

The entire FTIR spectrometer is preferably hermetically encapsulated. In the context of the invention, hermetic encapsulation of the FTIR spectrometer means, in particular, that there is no exchange of gases between the internal assembly of the FTIR spectrometer comprising the features mentioned in claim 1 and the space surrounding the FTIR spectrometer. Accordingly, the amount of water, in particular in the form of water vapor, in the interior of the FTIR spectrometer remains constant. Water or water vapor manifests characteristic oscillation modes in the wavelength range typically of interest in the analysis of infrared spectra. Hermetic encapsulation has the advantage that the oscillation modes remain constant during operation of the FTIR spectrometer and can be subtracted as background from the actual signal by a reference measurement. This improves the SNR.

The mode of operation of the FTIR spectrometer according to the invention described in the following by way of example: The infrared radiation source is operated, for example with the aid of electric current, and emits light at least in the infrared range. The light from the infrared radiation source is collimated, directed to the interferometer and strikes the beam splitter in the interferometer. The beam splitter divides the light into two individual beams. A first individual beam is reflected in the first arm by a first mirror back to the beam splitter. A second individual beam is reflected by a second mirror back to the beam splitter. At least one of the two arms or even both arms are variable in length. In the case of a mirror that can be moved along a linear axis, the control system shifts the mirror periodically between a first and a second inflection point by means of a control element and accordingly changes the length of the arm. In the case of a rotatable rocker, the control system regulates the drive of the rocker in such a way that the rocker executes a pendulum movement between two end points relative to the stationary beam splitter, wherein one arm is shortened and the other arm is lengthened relative to the beam splitter. After reflection at the mirrors of the two arms, the two individual beams are recombined in the beam splitter, interfere, and leave the interferometer.

To record a reference spectrum of the infrared light, i.e. a spectrum of the infrared light without interaction of the light with the sample, the infrared light is reflected through a part of the mirror arrangement in the direction of the measuring cell after leaving the interferometer. In the measuring cell, the light beam couples into the sample interface, i.e. an ATR crystal, for example. However, the sample interface is not in contact with the sample or the sample material. The infrared light which leaves the sample interface carries the information characteristic of the sample interface, for example the absorption of the ATR crystal. The light is directed onto the infrared detector by means of another part of the mirror arrangement and measured there. This reference spectrum is used later in the calculation of the infrared spectra.

To record a sample spectrum, i.e. the recording of a spectrum of the infrared light after an interaction of the infrared light with the sample or respectively the sample material, the infrared light is reflected through a part of the mirror arrangement in the direction of the measuring cell after leaving the interferometer. In the measuring cell, the light beam couples into the sample interface, for example into an ATR crystal. The light that leaves the sample interface, i.e. for example the ATR crystal, carries characteristic information for the sample or respectively the sample material and for the sample interface, for example the ATR crystal. The light is directed onto the infrared detector by reflection by means of another part of the mirror arrangement and detected by the infrared detector.

In addition to the infrared light that leaves the sample, the infrared detector or a separate detector, for example a separate photodiode, preferably detects the reference laser beam, which is also guided through the interferometer and interferes there. The reference laser beam and the light beam from the infrared radiation source do not interact or interact only negligibly with each other.

The infrared light recorded by the infrared detector that leaves the sample, i.e. the sample signal, and the signal from the reference laser beam are, for example, recorded and processed by the control system or a separate measuring computer. The sample signal is preferably Fourier transformed and corrected for the reference spectrum. Corresponding methods are known in the prior art. A path difference of the arms in the interferometer is assigned to the signal of the reference laser beam. The desired infrared spectra are calculated from the processed sample signal and the path difference by means of methods known in the prior art.

The FTIR spectrometer has the advantage that it eliminates the disadvantages in the prior art. In particular, the optical system of the FTIR spectrometer according to the invention can be produced with simple technical means. The optical system can also be produced with little technical effort. Furthermore, the optical system can be produced economically and in a short time from materials largely available in specialized stores and are easy to process. This greatly reduces both the production effort of the FTIR spectrometer as well as the production costs. By simplifying the technical production effort, the FTIR spectrometer according to the invention is also more sustainable than comparable known FTIR spectrometers.

Expressed otherwise, the FTIR spectrometer according to the invention enables the largest possible amount of light from an extended, broadband light source to be coupled into and out of a sample in contact with a sample interface, which can preferably be an ATR crystal, in order to maximize the SNR in the FTIR spectrometer. The production effort and the costs of the optical components in the form of mirrors as a significant price factor of the FTIR spectrometer are kept as low as possible without having to engage in compromises with the signal quality. This is done using an achromatic optical assembly, in particular of the mirror arrangement, which consists partly or even exclusively of identical reflecting mirrors and avoids absorption as well as dispersion in transmissive optical systems.

Another and surprising advantage of the FTIR spectrometer according to the invention is that all mirrors of the mirror arrangement are arranged outside the interferometer, and therefore there are no high requirements on wavefront errors and accordingly the quality of the optical surface of the mirrors of the mirror arrangement. Wavefront errors of the mirrors of the mirror arrangement then do not have an effect in the form of an interferometric contrast, but only in the achievable transmission through the optical assembly. The special arrangement of the mirrors of the mirror arrangement outside the interferometer makes it possible to use the materials described in the context of this invention for the main body.

In a preferred embodiment of the FTIR spectrometer, at least one mirror of the mirror arrangement outside the interferometer has a mirror shape or a combination of mirror shapes from the following list: an off-axis parabolic mirror, a parabolic mirror, a compound parabolic concentrator, a spherical concave mirror, a mirror that has at least in one axis the shape of at least one parabolic segment or a circular segment.

Within the meaning of the invention, the mirror shape of a mirror of the mirror arrangement or a combination of mirror shapes of a mirror of the mirror arrangement describes either just the geometric design of the reflecting surface of the mirror of the mirror arrangement or the entire or partial geometric design of the mirror of the mirror arrangement.

Within the meaning of the invention, a parabolic mirror is a concave mirror in the form of an axially symmetrical section of a paraboloid of revolution, wherein the focal point is arranged on the axis of symmetry of the section of the paraboloid of revolution. A paraboloid of revolution is a concave surface which is described by a rotation of a parabola about an axis. Within the meaning of the invention, an off-axis parabolic mirror is an asymmetric section of a paraboloid of revolution, wherein the section has an offset from the axis of symmetry of the paraboloid of revolution and from the focal point. Within the meaning of the invention, a compound parabolic concentrator is a non-imaging mirror that bundles all incident light within the largest possible acceptance angle on one surface. Within the meaning of the invention, a spherical concave mirror is a concave mirror whose shape can be represented by a section of a hollow sphere.

Such mirrors have the advantage that they either effectively deflect and simultaneously focus incident light, in particular infrared radiation (parallel incident light beams) or deflect and simultaneously collimate it (divergent incident light beams). Such mirrors are also easy to produce. Another advantage of the assembly with the mirrors described herein is the reduction of absorption and dispersion of the infrared light in optical elements in the FTIR spectrometer according to the invention outside the interferometer. In particular, this significantly reduces a wavelength-dependent transmission of the infrared light.

In a preferred embodiment of the FTIR spectrometer, each mirror of the mirror arrangement outside the interferometer has a mirror shape or a combination of mirror shapes from the following list: an off-axis parabolic mirror, a parabolic mirror, a compound parabolic concentrator, a spherical concave mirror, a mirror that has at least in one axis the shape of at least one parabolic segment or a circular segment.

The advantage of this assembly with purely reflecting optical elements outside the interferometer is the complete avoidance of absorption and dispersion of the infrared light in optical elements in the FTIR spectrometer according to the invention. In particular, this significantly reduces or even completely avoids wavelength-dependent transmission of the infrared light. Moreover, the assembly of the FTIR spectrometer according to the invention is further simplified. The production effort and complexity of the optical components of the FTIR spectrometer are also significantly reduced since the mirror designs are technically easy to produce by using the production methods as well as the material of the main bodies. This also has the great advantage of reduced production costs for the mirrors and the FTIR spectrometer.

In a preferred embodiment of the FTIR spectrometer, at least one of the mirrors of the mirror arrangement whose main body is made of a plastic material or has a plastic material, is produced by an injection molding process or a 3D printing method, and the reflecting surface is at least partially formed by a metal coating.

Within the meaning of the invention, the production of a mirror of the mirror arrangement is in particular also understood to mean the production of the main body of the mirror and the production of the reflecting surface of the mirror.

Within the meaning of this invention, an injection molding process describes a master molding method known in the prior art in which a plastic material is liquefied (plasticized) with an injection molding machine and injected under pressure into a mold, the injection mold. After the plastic material in the injection mold has cooled or the plastic material in the injection mold has cross-linked, the plastic material changes to a solid state and can be removed.

Within the meaning of this invention, a 3D printing method describes a production method known in the prior art from the field of additive production. Typical examples can be the following technologies: Fused deposition modeling (FDM), fused filament fabrication (FFF), direct ink writing (DIW), composite filament fabrication (CFF), stereolithography (SLA), digital light processing (DLP) and/or continuous liquid interface production (CLIP).

The metal coating can, for example, have one or more of the following materials or consist of one material or a combination of materials: Aluminum, gold, silver, rhodium, nickel, chromium, platinum, copper. The metal coating can be applied, for example, by vapor deposition of the surface of the main body to be coated, for example with the help of the process of physical vapor deposition (PVD) or chemical vapor deposition (CVD). Alternatively or additionally, the metal coating can be carried out by immersing at least the surface of the main body to be coated in a metal bath or by spraying the surface of the main body.

Alternatively to the aforementioned methods, it is also conceivable that at least one or all of the mirrors or their main bodies are produced by methods of milling or cutting known in the prior art. Preferably, at least one or all of the mirrors that are produced by one or more of the aforementioned methods can be post-processed in a step following the production process. Examples of preferred post-processing techniques are milling, cutting, grinding and polishing.

Preferably, one or more mirrors of the mirror arrangement whose main body is made of a plastic material or has a plastic material and is produced by an injection molding process or a 3D printing method, or respectively its reflecting surface, is only partially illuminated. Preferably, the reflecting surface of the mirror of the mirror arrangement of the FTIR spectrometer according to the invention is only illuminated to a maximum of 98%, particularly preferably to 95%, even more preferably to 93% of the entire reflecting surface of the mirror or mirrors. It is particularly preferred that the reflecting surface is only illuminated in a region that contributes to successful focusing or successful collimation of the infrared light. Successful focusing or collimation exists when less than 5%, preferably less than 3%, of the reflected light does not reach the closest optical element or infrared detector in the beam path. Within the meaning of the invention, the illuminated surface is preferably designed symmetrical and/or arranged symmetrically in relation to a center point of the reflecting surface. This has the advantage that the edge does not contribute to the reflection of the mirror. As a result, the reflection of the mirror is significantly more controlled, or respectively the light reflected by the mirror is significantly more homogeneous and symmetrical.

The mirrors of the mirror arrangement that are described in the context of the invention are preferably held by a mirror holder. Preferably, a part or the entire mirror holder can be produced by means of an injection molding method or a 3D printing method. In so doing, the same materials as already described in the context of the invention in connection with the mirrors described above can be used. Alternatively, for example, fiber-reinforced polyamide can also be used as a material for part or the entire mirror holder.

Mirrors produced in this way for reflecting infrared light have the advantage that they can be produced with simple and known means and with little technical effort in comparison to mirrors that are produced using methods known in the prior art. Moreover, the described production methods allow the production of large quantities in a short time. From the aforementioned advantages, significantly lower production costs per mirror also result in comparison to prior art production methods for mirrors for reflecting infrared light.

Finally, the mirrors produced by the described methods are suitable for use in FTIR spectrometers. The mirrors described here for reflecting infrared light in particular meet the high quality requirements for optical components for use in FTIR spectrometers. This represents an overcoming of a long prejudice in the prior art.

In a preferred embodiment of the FTIR spectrometer, the plastic material is at least one material from the following list or has at least one material from the following list: Polymethyl methacrylate (PMMA), polycarbonate (PC), cycloolefin polymer, cycloolefin copolymer, styrene acrylonitrile, styrene acrylonitrile, polycarbonate high temperature, polysulfone (PS), polyamide (PA), polycarbonate high refractive, polyester high refractive, polyethylene terephthalate (PET), polyethylene terephthalate with glycol (PETG), acrylonitrile-butadiene-styrene copolymer (ABS), nylon, polylactic acid (PLA), polyurethane (PU), a light-curing plastic (photopolymer), for example acrylic, epoxy and/or vinyl ester resin.

Preferably, the plastic material can also be a combination of two materials from the aforementioned list.

Particularly preferably, the plastic material has polycarbonate (PC) or the plastic material is polycarbonate. Mirrors according to the invention with a main body consisting of polycarbonate have the advantage that they have a low wavefront error in the reflection of infrared light. They are also economical to produce and easy to process and produce. Furthermore, it has been shown that mirrors consisting of polycarbonate can achieve an excellent surface roughness of <10 nm.

PLA and PETG are particularly easy to process in 3D printing. ABS has a higher melting point, is very rigid and scratch-resistant as well as moisture-repellent and, despite the high mechanical robustness, is easy to process mechanically. Particularly smooth surfaces are possible in the use of PMMA and PC. With a light-curing plastic (photopolymer), for example acrylic, epoxy and/or vinyl ester resin or others, very smooth surfaces can also be produced, for example by means of stereolithography methods (SLA or DLP methods). These smooth surfaces are particularly advantageous for use as a surface for applying a reflecting surface of a mirror. All the aforementioned materials have the advantage that they are easy to process. Moreover, metal coatings adhere particularly well to the materials mentioned herein. The aforementioned materials are also suitable for the aforementioned production methods, in particular for use in the injection molding method and/or use in the 3D printing method. Moreover, the aforementioned materials have advantageous temperature properties for use in an FTIR spectrometer. The aforementioned materials are also easy to process and rework and are economical.

Preferably, the plastic material can have a fiber material in addition to the aforementioned materials and accordingly at least sectionally form a composite material. The fiber material can be carbon fibers or glass fibers, for example. The addition of fibers generally improves the mechanical as well as, in particular, the temperature-dependent properties of the plastic material.

In a preferred embodiment of the FTIR spectrometer, the reflecting surface of at least one mirror of the mirror arrangement at least regionally has a free-form optical system.

Within the meaning of the invention, a free-form optical system is a reflecting surface that differs from spherical and parabolic geometries. For example, a free-form optical system can be a reflecting surface that at least regionally differs from the mirror shapes mentioned in claims 2 and 3 or combinations thereof.

By using free-form optical systems, beam shaping properties and beam deflection properties of the mirrors can be adjusted and achieved in a controlled manner that are not possible with simpler designs. This can further improve the efficiency of the FTIR spectrometer.

In a preferred embodiment of the FTIR spectrometer, the free-form optical system has at least regionally a shape deviation from one of the following mirror shapes: an off-axis parabolic mirror, a parabolic mirror, a compound parabolic concentrator, a spherical concave mirror, a mirror that has at least in one axis the shape of at least one parabolic segment or a circular segment.

In a particularly preferred embodiment of the FTIR spectrometer, the free-form optical system has at least regionally or completely a shape deviation from the following mirror shapes: an off-axis parabolic mirror, a parabolic mirror, a compound parabolic concentrator, a spherical concave mirror, a mirror that has at least in one axis the shape of at least one parabolic segment or a circular segment.

Within the context of simulations, it has been shown that deviations in shape can positively effect beam shaping. For example, by combining a spherical portion into a parabolic shape, a more targeted, advantageous reflection and focusing of a light beam can be achieved. The provision of mirrors with free-form optical systems is easy and economical to implement in the context of the production methods mentioned in this invention, in particular also with regard to the methods known in the prior art.

In a preferred embodiment of the FTIR spectrometer, the free-form optical system at least regionally has a shape deviation in and edge region.

In a particularly preferred embodiment of the FTIR spectrometer, the free-form optical system has a shape deviation in an edge region.

Preferably, the free-form optical system of the FTIR spectrometer has a shape deviation from the following mirror shapes in an edge region: an off-axis parabolic mirror, a parabolic mirror, a compound parabolic concentrator, a spherical concave mirror, a mirror that has at least in one axis the shape of at least one parabolic segment or a circular segment.

Within the meaning of this invention, the edge region preferably describes the transition between the reflecting surface and the main body of a mirror.

Particularly preferably, the edge region has a minimum extension or minimum radius of 1 mm, preferably 2 mm, more preferably 3 mm. It has been shown that this region is particularly advantageous for beam shaping and guidance.

In a preferred embodiment of the FTIR spectrometer, the shape deviation is a convex regular or irregular rounding or chamfer or a combination of a convex regular or irregular rounding and/or a chamfer.

The provision of such a rounding or chamfer has the advantage that unwanted scattered light can be avoided in the reflection of infrared light. Alternatively or additionally, scattered light can be reflected into regions within the FTIR spectrometer according to the invention in which it does not interfere with or negatively influence the measurement signal by a corresponding design of the rounding and/or chamfer sections.

In a preferred embodiment of the FTIR spectrometer, at least one mirror of the mirror arrangement or each mirror of the mirror arrangement is designed and configured in such a way that upon the reflection of infrared light at the particular mirror of the mirror arrangement, the infrared light has a maximum wavefront error per mirror of 50 times the wavelength, preferably 25 times the wavelength of the infrared light.

Within the meaning of the invention, a wavefront error describes a spatial phase shift between light waves which, considered together, form a light beam.

The wavefront error is largely determined by the macroscopic shape of the mirrors of the mirror arrangement outside the interferometer described in the context of the invention. Alternatively, the wavefront error can be determined by the surface quality of the mirrors of the mirror arrangement outside the interferometer described in the context of the invention. Alternatively, the wavefront error can be determined by a combination of the macroscopic shape and the surface quality of the mirrors outside the interferometer described in the context of the invention.

The mirrors of the mirror arrangement outside the interferometer described in the context of this invention comprise a main body and a reflecting surface. In the context of the invention, the macroscopic shape of a mirror of the mirror arrangement according to the invention outside the interferometer describes the outer geometric design of the mirror or respectively the outer geometric design of the reflecting surface. A non-exhaustive list of examples of macroscopic design elements that can be combined with each other can be the following: Bulges, indentations, notches, edges, planes, recesses or other known regular or irregular surface designs.

In the context of the invention, the surface quality of a mirror of the mirror arrangement according to the invention outside the interferometer describes the microscopic design of one or more interfaces of the mirror according to the invention or respectively the reflecting surface. The interface can be the reflecting surface of the mirror or comprise or support it. In particular, the interface of a mirror described in the context of the invention can be the region below the reflecting coating. Alternatively or additionally, the interface of the mirror according to the invention described above can be the reflecting surface of the mirror on the main body. An example of a measure for the surface quality is the roughness of a surface or the interface.

The wavefront error can be decisively determined by the macroscopic shape of at least one mirror of the mirror arrangement according to the invention outside the interferometer. Preferably, the wavefront error can be decisively determined by the macroscopic shape of each mirror of the mirror arrangement outside the interferometer.

The wavefront error can be decisively determined by the surface quality of at least one mirror of the mirror arrangement according to the invention outside the interferometer. More preferably, the wavefront error can be decisively determined by the surface quality of each mirror of the mirror arrangement outside the interferometer.

Particularly preferably, the wavefront error can be decisively determined by the macroscopic shape and the surface quality of at least one mirror of the mirror arrangement outside the interferometer. Also particularly preferably, the wavefront error can be decisively determined by the macroscopic shape and the surface quality of each mirror of the mirror arrangement outside the interferometer.

Preferred examples of the above-described optical systems with low optical quality are optical systems with a maximum wavefront error of 50 times the wavelength of the reflected light, preferably 25 times the wavelength, more preferably 12.5 times the wavelength, particularly preferably 10 times the wavelength.

Particularly preferably, the macroscopic shape of at least one mirror of the mirror arrangement outside the interferometer or of each mirror of the mirror arrangement outside the interferometer can be designed and configured in such a way that, upon the reflection of infrared light at the particular mirror of the mirror arrangement, the infrared light has a maximum wavefront error per mirror of 50 times the wavelength of the infrared light, preferably 25 times the wavelength of the infrared light, more preferably 12.5 times the wavelength, and particularly preferably 10 times the wavelength.

Particularly preferably, the surface quality of at least one mirror of the mirror arrangement outside the interferometer or of each mirror of the mirror arrangement outside the interferometer can be designed and configured in such a way that, upon the reflection of infrared light at the particular mirror of the mirror arrangement, the infrared light has a maximum wavefront error per mirror of 50 times the wavelength of the infrared light, preferably 25 times the wavelength of the infrared light, more preferably 12.5 times the wavelength, and particularly preferably 10 times the wavelength.

Particularly preferably, the macroscopic shape and the surface quality of at least one mirror of the mirror arrangement outside the interferometer or of each mirror of the mirror arrangement outside the interferometer can be designed and configured in such a way that, upon the reflection of infrared light at the particular mirror of the mirror arrangement, the infrared light has a maximum wavefront error per mirror of 50 times the wavelength of the infrared light, preferably 25 times the wavelength of the infrared light, more preferably 12.5 times the wavelength, and particularly preferably 10 times the wavelength.

The mirror shapes described in the context of this invention with the structure of a mirror of the mirror arrangement consisting of a main body and reflecting surface described in the context of this invention enable such a low maximum wavefront error, in particular due to their macroscopic shape of the mirror and/or the surface quality of the mirror. Moreover, a grinding or polishing step can be carried out before applying the metal coating to the main body. In this context, a metal coating is an example of an advantageous coating that provides a reflecting surface. Grinding and polishing steps are examples of means known in the prior art for processing the macroscopic shape and the surface finish. In addition or alternatively to the grinding and polishing steps, other means known in the prior art for processing the macroscopic shape and the surface quality are also conceivable. For example, the surface roughness can be minimized by grinding and/or polishing steps. This also minimizes the wavefront error. In particular, the wavefront error can be minimized by the processing of the surface quality of the main body before and/or after the application of the metal coating or the provision of the reflecting surface.

A worsening of the wavefront outside the interferometer only results in a loss of efficiency, which is not relevant for the recording and processing of the infrared spectra up to the aforementioned maximum per mirror for the wavefront error.

Due to this surprising property, the efficiency of the mirror arrangement used in the context of the invention, which has the aforementioned maximum wavefront error, remains comparable to the efficiency of mirrors that are used in FTIR spectrometers known in the prior art, but with significantly reduced costs and less production effort.

In a preferred embodiment of the FTIR spectrometer, the mirrors of the mirror arrangement and the interferometer are designed and configured in such a way that upon the reflection of infrared light at all mirrors of the mirror arrangement, the infrared light has a total maximum wavefront error of 300 times the wavelength of the infrared light. Preferably, the mirrors of the mirror arrangement outside the interferometer are designed and configured in such a way that upon the reflection of infrared light at all mirrors of the mirror arrangement, the infrared light has a total maximum wavefront error of 300 times the wavelength of the infrared light, preferably 200 times the wavelength of the infrared light.

Particularly preferably, the macroscopic shape and/or surface properties of the mirrors of the mirror arrangement outside the interferometer are designed and configured in such a way that upon the reflection of infrared light at all mirrors of the mirror arrangement outside the interferometer, the infrared light has a total maximum wavefront error of 300 times the wavelength of the infrared light, preferably 200 times the wavelength of the infrared light of the infrared light.

The wavefront of the infrared light is no longer modified within the interferometer. As a result, there is no difference between the interference of two light beams with identical wavefronts with a high wavefront error in comparison to interference with light beams with perfectly flat wavefronts. The wavefront error already present before the entry into the interferometer is therefore retained after the entry into the interferometer, split in the beam splitter, and then recombined. Another worsening from errors in the optical systems, in particular the mirrors of the mirror arrangement, merely results in a loss of efficiency which, however, is not relevant for the recording and processing of the infrared spectra in the FTIR spectrometer according to the invention up to the aforementioned maximum for the total wavefront error from the mirror arrangement.

Due to this surprising property, the efficiency of the mirror arrangement used in the context of the invention remains comparable to the efficiency of FTIR spectrometers known in the prior art with the aforementioned maximum wavefront error, but with significantly reduced costs and less production effort.

In a preferred embodiment of the FTIR spectrometer, the mirror arrangement has at least two off-axis parabolic mirrors with a first focal length and at least two parabolic mirrors with a second focal length.

Preferably, at least four mirrors are arranged along the beam path in the following sequence: off-axis parabolic mirror (with first focal length f1)—parabolic mirror (with second focal length f2)—sample interface (for example ATR crystal)—parabolic mirror (with second focal length f2) 1'off-axis parabolic mirror (with first focal length f1). The first and second focal lengths f1 and f2 preferably do not have the same values. The second focal length f2 can, for example, lie in the range from 1 mm to 2.5 mm, preferably 1.7 mm. Preferably, the ATR crystal has a maximum area of contact with the sample that is smaller than 2.5 mm by 2.5 mm.

The use of the above-described mirror arrangement with the four above-described mirrors allows the provision of an intermediate focus for setting the resolution. Moreover, parallel beams through an off-axis parabolic mirror before and after the sample interface, preferably an ATR crystal, allow a variable distance to the remaining optical system in the FTIR spectrometer without thereby changing the imaging properties. Furthermore, parallel beams before and after the sample interface in the measuring cell enable simple exchange of the sample interface. For example, a sample interface in the form of an ATR crystal can be exchanged with another single or multiple reflection ATR, transmission and/or DRIFTS assembly.

Alternatively, the parabolic mirror can also be designed in one piece as a single parabolic mirror before and after the sample interface. An example of this is a parabolic mirror or CPC as used in conventional flashlights. In this case, the sample interface, for example the ATR crystal, can be arranged in an opening in the focal point of the one-piece parabolic mirror. The positioning of the sample interface or respectively ATR crystal in the focal point of the parabolic reflector allows a very compact as well as economical assembly for coupling light into or out of the sample. Moreover, such an assembly is robust and avoids or reduces the problems from misalignment of the mirror arrangement.

In a preferred embodiment of the FTIR spectrometer, the sample interface is an ATR crystal that is accommodated in a holder, wherein the holder is produced from metal in a 3D printing method.

Within the meaning of this invention, the 3D printing method for metal comprises any 3D printing method for printing metal known and suitable in the prior art.

Preferably, the 3D printing method from metal has a print resolution per layer of a maximum 230 μm. This ensures the necessary fit of the ATR crystal in the holder.

Preferably, the holder has at least one web or a receptacle that is designed and configured in such a way as to transfer or absorb compressive forces on the diamond to the holder as an abutment for the diamond. Compressive forces can arise, for example, when pressing samples onto the ATR crystal. With such a design of the holder, a long-lasting and safe use of the holder and the ATR crystal accommodated therein is ensured.

The web can divide an opening passing through the holder from a top side to a bottom side into two sections or respectively two openings on a bottom side, wherein the sections are configured to allow the infrared light falling into the ATR crystal and the infrared light falling out of the ATR crystal to pass through once the ATR crystal is accommodated in the holder. The opening can be designed on the top side in such a way that the ATR crystal can be inserted thereinto with an exact or almost exact fit and can end flush with a surface of the top side. In this case, the top side can be a region in which the ATR crystal can be brought into contact with a sample or sample material.

Preferably, the holder is printed from stainless steel or titanium. Stainless steel and titanium can absorb high tensile and compressive forces and are chemically inert.

Preferably, the ATR crystal is glued into the holder with an adhesive or soldered in with a solder. Also preferably, the ATR crystal is glued into the holder in such a way that the opening in the top side of the holder is closed fluid-tight by the ATR crystal and the adhesive or the solder. Both gluing and soldering are joining methods that can be carried out with little technical effort, high precision and low costs.

Preferably, the solder comprises or the solder with which the ATR crystal is soldered into the holder is silver solder with or without titanium content. Both mentioned types of solder have advantageous wetting and bonding properties with both the ATR crystal, preferably diamond, and the holder consisting of stainless steel or titanium. This gives rise to a strong and durable connection between the ATR crystal and the holder.

Preferably, soldering is done in a vacuum furnace. This ensures that the ATR crystal, preferably a diamond, is not damaged during soldering.

As already mentioned, the gluing or respectively the soldering site of the ATR crystal in the holder preferably forms an airtight and watertight seal of the opening in the top side of the holder. This has the advantage that, in the mounting of the holder with the ATR crystal in the FTIR spectrometer, the hermetic encapsulation of the FTIR spectrometer is still guaranteed, and there is no additional entry of water in the FTIR spectrometer.

The holder can be produced according to the following production process, for example, taking into account the aforementioned properties:
Printing the holder consisting of metal, preferably consisting of stainless steel or titanium, more preferably with a print resolution per layer of a maximum 230 μm, and
Soldering of an ATR crystal, preferably in a vacuum furnace, more preferably with a silver solder with or without titanium content.

Preferably, the ATR crystal can be soldered into a holder consisting of stainless steel. This is possible due to the production of the holder from 3D-printed metal in combination with the soldering of the ATR crystal into the holder, despite the different thermal expansion coefficients of stainless steel and, for example, diamond as the material for the ATR crystal. Holders consisting of molybdenum known in the prior art are significantly more complex and expensive to make than the aforementioned assembly. Due to the lower cost of stainless steel, the entire holder can be 3D-printed in one part so that precise and tight fitting of a diamond holder consisting of molybdenum into a larger stainless steel holder, as is usual in the prior art, is unnecessary.

The production of the holder from metal by means of 3D printing methods, and in particular according to the above-described process, generally has the advantage that it is significantly simpler and more economical in comparison to conventional production methods such as milling or spark erosion from a solid material. Moreover, geometries can be realized with the help of the 3D printing method that can only be achieved with great effort or not at all with conventional production methods. Such a holder can be produced in small dimensions and can absorb the high pressures arising during contact between the ATR crystal and sample or respectively sample material without destroying or damaging the holder.

In a preferred embodiment of the FTIR spectrometer, the holder is configured to hold the ATR crystal stationary at a contact pressure of the sample of up to 130 web on the ATR crystal.

Such pressures are necessary to ensure the necessary coupling of light into and out of the sample through the ATR crystal. The holder described in the context of the invention can withstand such pressures, in particular due to the provided web and from way of fixing the ATR crystal in the holder.

In a preferred embodiment of the FTIR spectrometer, the ATR crystal has a maximum sample contact surface of 3 mm by 3 mm.

In the context of the invention, the sample contact surface is the maximum surface of the ATR crystal that can come into contact with a sample or respectively a sample material. When using the above-described holder, the sample contact surface lies on the top side of the holder and is defined by the surface of the ATR crystal in the holder, which ends flush with the surface of the holder.

Preferably, the maximum sample contact surface is a maximum of 2.8 mm by 2.8 mm, more preferably 2.5 mm by 2.5 mm, even more preferably 2.0 mm by 2.0 mm. Small sample contact surfaces are also reflected in the overall dimensions of the ATR crystal, which is why small ATR crystals can be used for small sample contact surfaces. Accordingly, less ATR crystal material is required, which simplifies production and reduces costs.

In a preferred embodiment, the FTIR spectrometer according to the invention is used according to one of the aforementioned embodiments for measuring a sample with pharmaceutical substances. Particularly preferably, the FTIR spectrometer according to the invention is used in accordance with one of the aforementioned embodiments to measure a sample with pharmaceutical substances. Such quality determinations can, for example, be performed in pharmacies or by pharmacists. In particular, the quality determination can comprise one or more points: Determining the identity of a preferably pharmaceutical substance, determining a concentration of one or more pharmaceutical substances in the sample, determining the purity of one or more pharmaceutical substances in the sample, determining a concentration of impurities in the sample, qualitatively determining impurities, in particular the type, in the sample.

It is hereby noted that one or more of the above-described preferred embodiments can be combined with each other, to the extent free from contradictions, and are also preferred embodiments.

In the following, preferred embodiments of the invention are explained and described in more detail with reference to the accompanying drawings in which:

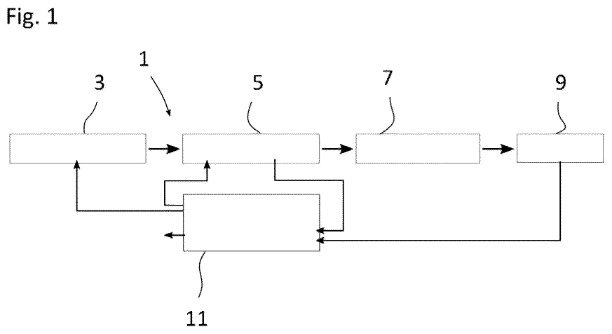

FIG. 1 Shows a schematic representation of the assembly of an FTIR spectrometer,

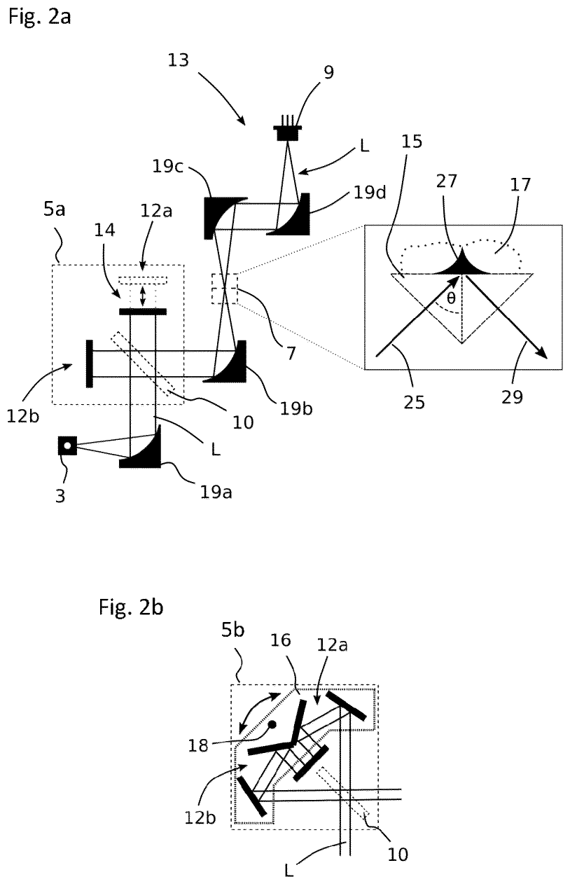

FIG. 2a,b show an exemplary schematic beam path of the FTIR spectrometer according to the invention from FIG. 1 with two different embodiments of a spectrometer assembly,

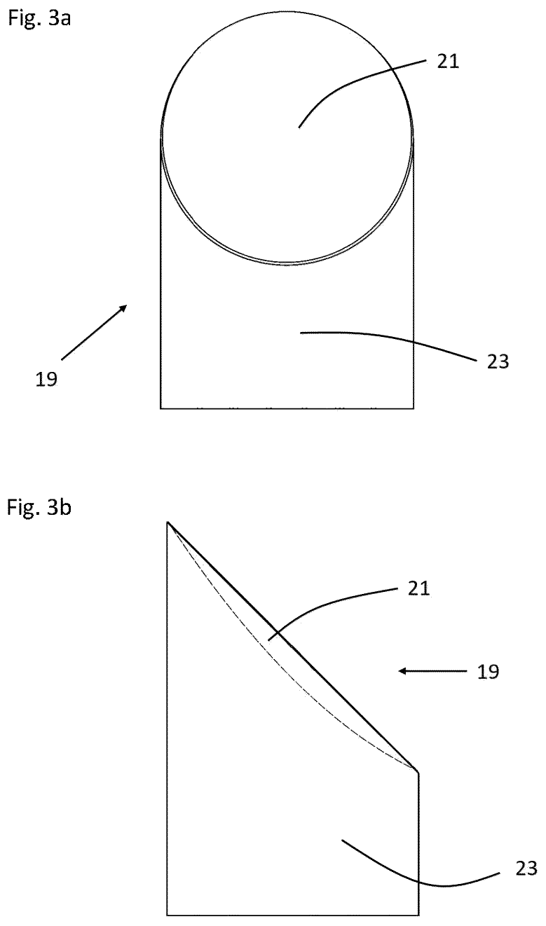

FIG. 3a,b show two views of an exemplary schematic assembly of a mirror of the mirror arrangement of the FTIR spectrometer according to the invention,

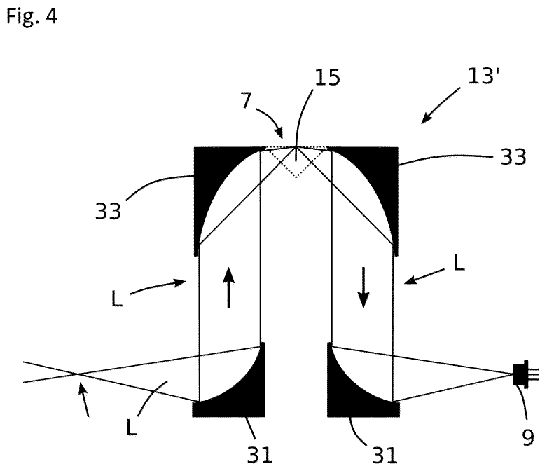

FIG. 4 shows a second, alternative schematic beam path of a part of the FTIR spectrometer according to the invention,

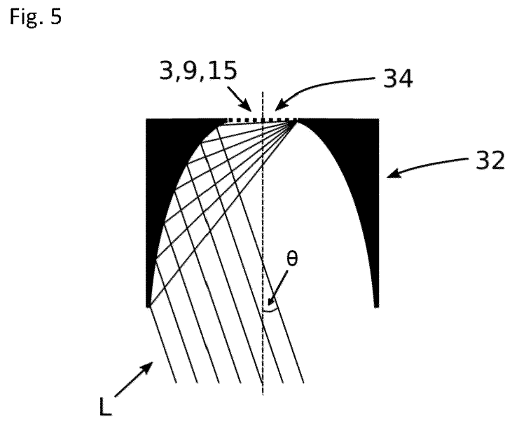

FIG. 5 shows an exemplary beam path within a compound parabolic concentrator mirror,

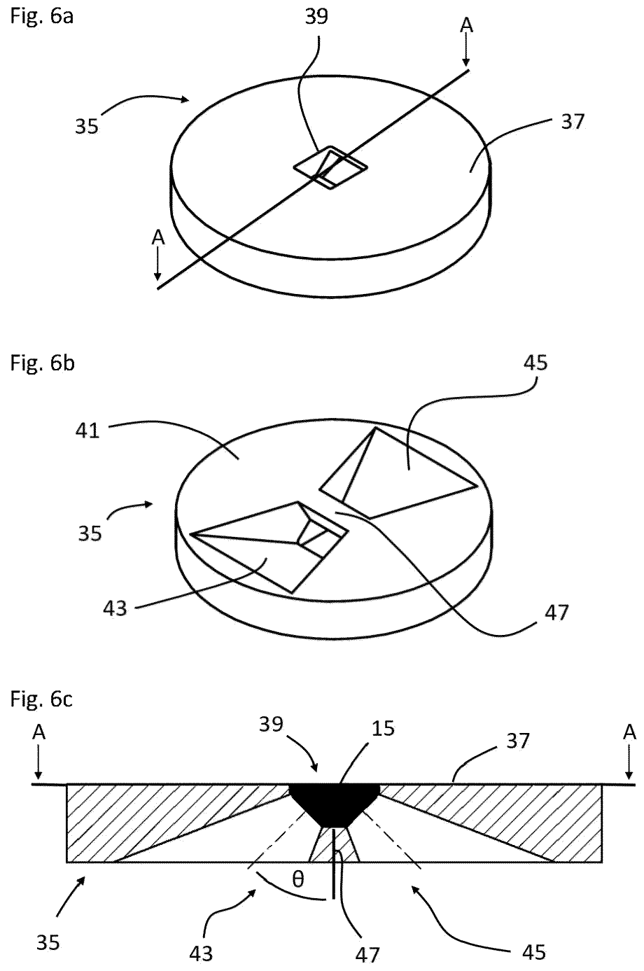

FIG. 6a-c show various views of an assembly of a holder for an ATR crystal,

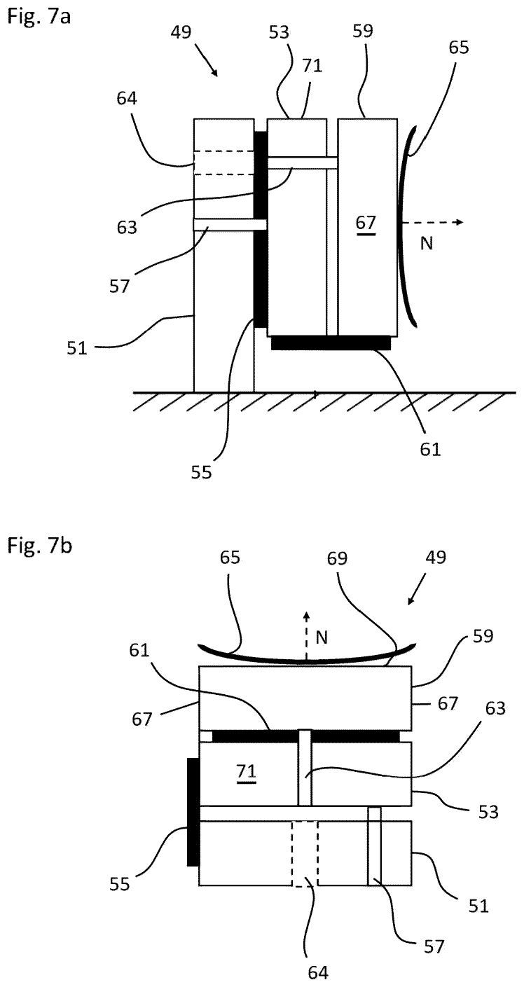

FIG. 7a,b show two views of an exemplary mirror holder in the interferometer of the FTIR spectrometer according to the invention,

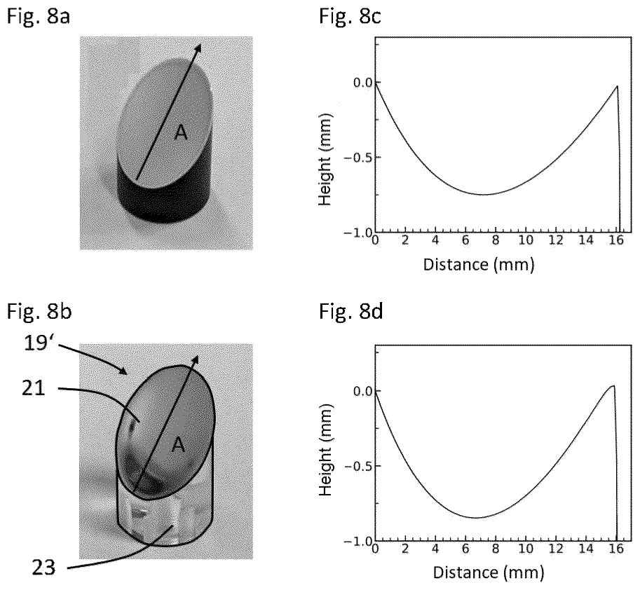

FIG. 8a-h show measurement results for measured parameters of mirrors of the mirror arrangement of the FTIR spectrometer according to the invention in comparison with commercially available precision metal mirrors,

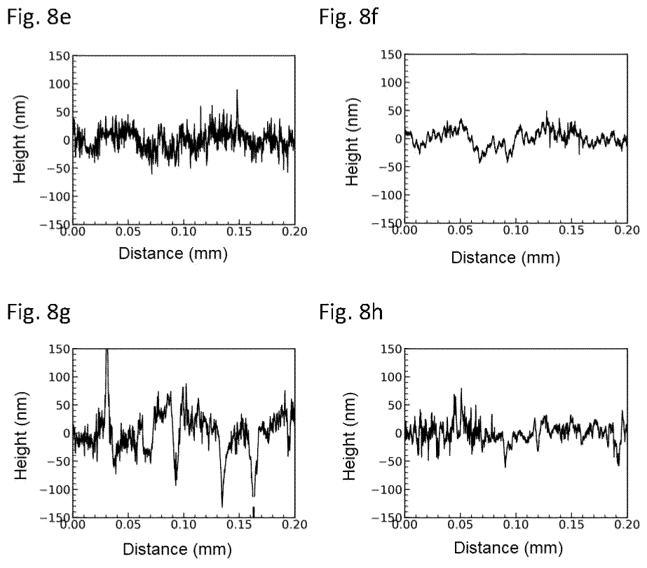

FIG. 9a,b show results of a simulation to determine the transmission or light intensity of the mirror arrangement depending on the maximum wavefront error through the mirrors of the mirror arrangement in the FTIR spectrometer according to the invention,

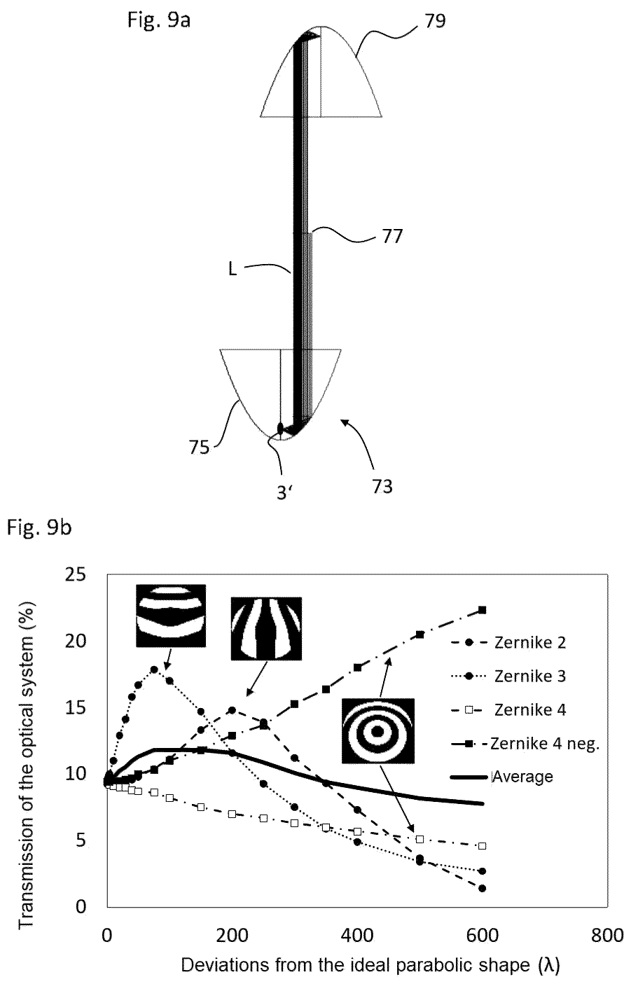

FIG. 10a,b show exemplary FTIR spectra that were recorded with an FTIR spectrometer according to the invention based on the mirror arrangement according to the invention with injection-molded mirrors and a mirror arrangement with commercially available precision metal mirrors for comparison of the results, and

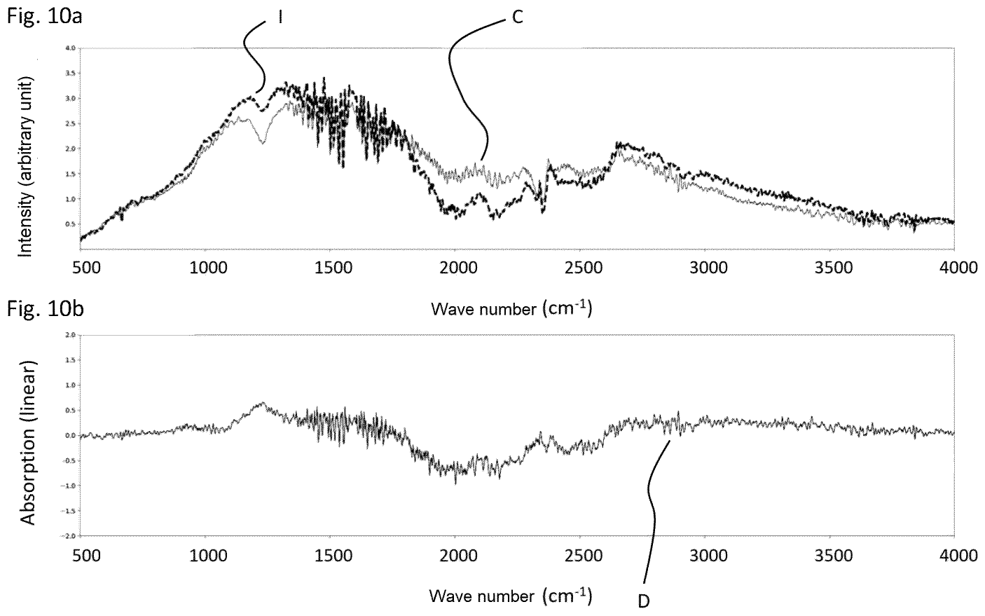

FIG. 11a-h show various spatially resolved measurements of wavefront errors of metal precision mirrors and various embodiments of mirrors according to the invention.

FIG. 1 shows a schematic representation of an assembly of an embodiment of an FTIR spectrometer 1 according to the invention. FIG. 2a schematically shows an exemplary beam path 13 of the FTIR spectrometer 1 with a first embodiment of an interferometer. FIG. 2b schematically shows an alternative assembly of an interferometer. The FTIR spectrometer 1 is described below:

The FTIR spectrometer 1 comprises an infrared radiation source 3, an interferometer 5a, 5b, a measuring cell 7, an infrared detector 9 and a control system 11.

The interferometer 5a typically has a first and a second arm 12a, 12b, wherein at least one arm is a variable-length arm 14. For example, the control system 11 can regulate a mirror offset of a mirror, movable along a linear axis, of the first arm 12a of the interferometer 5a by suitable actuation of a corresponding actuator or final control element. This changes the distance of the mirror of the arm with variable length 14 from the beam splitter 10, i.e. the length of the first arm 12a, and accordingly the distance to be traversed by the light L, also termed path length, in the first arm 12a.

Alternatively, the interferometer 5b can comprise a rocker 16 rotatable in one plane as shown in FIG. 2b. The rocker 16 is designed in such a way that it comprises, in particular, the mirrors of the interferometer 5b necessary for the reflection of both individual beams coming from the beam splitter 10. The rocker 16 therefore forms or respectively comprises both arms of the interferometer 5b. The control system 11 regulates a rotary movement, for example with the help of a drive of the rocker 16, in such a way that the rocker 16 executes a pendulum movement about an axis 18 between two end points relative to the stationary beam splitter. The rocker 16 can, for example, be driven using a voice coil.

The FTIR spectrometer 1 also has a reference laser. With the help of the reference laser, the position and an angle of inclination of at least one mirror of one or both arms of the interferometer 5a, 5b can be determined, or respectively a relative path length difference between the mirrors of the first and second arms 12a, 12b of the interferometer 5a, 5b can be determined.

The measuring cell 7 has a sample interface and can preferably comprise an ATR crystal 15 therein or theron, which can be brought into contact with a sample 17. The control system 11 is configured to change the length of the at least one arm of the interferometer.

The infrared detector 9 is configured to measure the intensity of the infrared light which is directed onto the infrared detector 9 after the interaction in the ATR crystal 15 or respectively the sample 17. The infrared detector 9 can, for example, be a pyroelectric sensor or comprise same. Alternatively or additionally, the infrared detector can be or comprise a photodiode.

In addition, the FTIR spectrometer 1 comprises a mirror arrangement 13 outside the interferometer 5a, 5b with at least two mirrors, for example four mirrors 19a, 19b, 19c, 19d as shown in FIG. 2a,b. Each mirror 19a-d comprises a reflecting surface 21 and a main body 23, which comprises the reflecting surface 21 (see FIG. 3a,b). The main body 23 of at least one mirror 19a-d or all mirrors 19a-d of the mirror arrangement 13 is or respectively are made of a plastic material and/or 3D printed metal. Alternatively, the main body 23 of at least one mirror 19a-d or of all mirrors 19a-d can have plastic material and/or 3D printed metal.

The mirror arrangement 13 is at least configured to direct a light beam, i.e. light L, from the infrared radiation source 3 through the interferometer 5a, 5b onto the sample interface of the measuring cell 7 and to direct the light beam from the sample interface of the measuring cell 7 onto the infrared detector 9.

The mode of operation of the FTIR spectrometer 1 according to the invention described in the following by way of example. The infrared radiation source 3 is operated and emits light Lat least in the infrared range. The light L from the infrared radiation source 3 is collimated by the mirror 19a into a light beam L and hits a beam splitter 10 in the interferometer 5a, 5b. The beam splitter 10 divides the light beam into two individual beams. A first individual beam is reflected in the first arm 12a by a first mirror back to the beam splitter 10. A second individual beam is reflected by a second mirror in the second arm 12b back to the beam splitter 10. At least one of the two arms or even both arms are variable in length. In the case of a mirror that is movable along a linear axis, the control system 11 shifts the mirror of the first arm 12a periodically between a first and a second inflection point relative to the stationary beam splitter 10 and accordingly changes the path length of the light in the first arm 12a, whereby the arm itself is an arm 14 variable in length. In the case of a rotatable rocker 16, the control system 11 regulates the drive of the rocker 16 in such a way that the rocker 16 executes a pendulum movement between two end points relative to the stationary beam splitter 10, and thereby shortens one arm 12a or respectively 12b and lengthens the other arm 12b or 12a. After reflection at the mirrors, the two individual beams are recombined in the beam splitter 10, interfere there, and leave the interferometer 5a, 5b as a light beam L.

The recording of a reference spectrum of the infrared light L has already been described above in connection with the invention.

A sample spectrum, i.e. a spectrum of the light that has left the ATR crystal 15 after an interaction with the sample 17, is now recorded as follows, analogous to the description above: the infrared light L, after leaving the interferometer 5a, 5b, is directed and focused in the direction of the measuring cell 7 by a part of the mirror arrangement 13, in the case of FIG. 2a,b by mirror 19b. In the measuring cell 7, the incident light 25 enters the ATR crystal 15 at an angle θ. At the interface between the ATR crystal 15 and sample 17, an evanescent wave 27 arises which interacts with the sample material. The light L leaves the ATR crystal 15 by the same angle θ as the outgoing light 29 and now carries characteristic information for the sample 17 or respectively the sample material. The light L is directed and focused onto the infrared detector 9 by means of another part of the mirror arrangement 13, i.e. in the case of FIG. 2a,b by mirrors 19c and 19d by reflection, and detected by the infrared detector 9.

In addition to the infrared light that leaves the sample 17, the infrared detector 9 or a separate detector, e.g. in the form of a separate photodiode, preferably detects the reference laser beam, which was also guided through the interferometer 5a, 5b and interferes there. The reference laser beam and the light beam from the infrared radiation source 3 do not interact or interact only negligibly with each other.

The infrared light L recorded by the infrared detector 9, that leaves the sample 17, i.e. the sample signal, and the signal of the reference laser beam are, for example, recorded and processed by the control system 11, which comprises, for example, a microcontroller or microprocessor or alternatively or additionally a separate measuring computer. In so doing, the sample signal is preferably Fourier transformed, for example using a known fast Fourier transform (FFT), and corrected for the reference spectrum. Corresponding methods are known in the prior art. A path difference of the arms in the interferometer 5a, 5b is assigned to the signal of the reference laser beam. The desired infrared spectra are calculated from the processed sample signal and the path difference by means of methods known in the prior art. FIG. 3a,b shows for example a schematic assembly of a mirror 19 of the mirror arrangement 13 of the FTIR spectrometer 1 according to the invention. The mirror 19 can, for example, be one, several or all of the mirrors 19a, 19b, 19c and/or 19d from FIG. 2a, b.

The mirror 19 comprises a reflecting surface 21 and a main body 23, which comprises the reflecting surface 21. The main body 23 is made of a plastic material and/or 3D printed metal. Alternatively, the main body 23 can have plastic material and/or 3D printed metal.

The reflecting surface 21 of the mirror 19 is preferably sectionally concave and/or designed as a concave mirror. The main body 23 of the mirror can comprise the reflecting surface or hold it directly or indirectly, e.g. via intermediate layers. The reflecting surface 21 can be connectable via the main body 23 to other parts of the FTIR spectrometer 1 according to the invention. For example, if the reflecting surface is a metal coating, the reflecting surface can be applied directly to a section of the surface of the main body. Alternatively, the metal coating can be applied to intermediate layers. The intermediate layers (or at least one of them) can in turn be applied directly to the section of the surface of the main body.

The main body 23 can be designed as a single piece together with the reflecting surface 21. In this case, the reflecting surface 21 is applied directly to a surface section of the main body 23. Alternatively, it is also conceivable for the reflecting surface 21 to be applied indirectly, i.e. for example on an intermediate layer on the surface section of the main body 23. The main body 23 can, for example, be connectable to a part, e.g. a part of the housing or a base plate of the FTIR interferometer 1 according to the invention.

Alternatively to the one-piece design, the main body 23 can be designed in several pieces (not shown) with at least a first and a second part (and possibly other parts such as spacers or the like). In this context, it is conceivable, for example, for the first part of the main body 23 to comprise the reflecting surface 21 directly on a surface section, as in the one-piece case, or comprises the reflecting surface 21 indirectly via an intermediate layer. The first part of the main body 23 can then be connectable with the second part of the main body 23 (and possibly further parts of the main body 23) to a part of the housing or a base plate of the FTIR interferometer according to the invention 1.

The mirror 19 or the reflecting surface 21 of the mirror 19 can have a mirror shape or a combination of mirror shapes from the following list: an off-axis parabolic mirror, a parabolic mirror, a compound parabolic concentrator, a spherical concave mirror, a mirror that has at least in one axis the shape of at least one parabolic segment or a circular segment.

In addition, the reflecting surface 21 of the mirror 19 of the mirror arrangement 13 can have a free-form optical system at least regionally. The free-form optical system has a at least regionally a shape deviation from one of the following mirror shapes: an off-axis parabolic mirror, a parabolic mirror, a compound parabolic concentrator, a spherical concave mirror, a mirror that has at least in one axis the shape of at least one parabolic segment or a circular segment.

It is also conceivable for the shape deviation to be a convex regular or irregular rounding or chamfer or a combination thereof.

Preferably, the mirror 19 of the mirror arrangement 13 is designed and configured in such a way that upon the reflection of infrared light L at the mirror 19 of the mirror arrangement 13, the infrared light L has a maximum wavefront error of 50 times the wavelength, preferably 25 times the wavelength of the infrared light L.

FIG. 4 shows a second, alternative schematic beam path of a part of the FTIR spectrometer 1 according to the invention. The assembly in FIG. 4 has a mirror arrangement 13′ with at least two off-axis parabolic mirrors 31 with a first focal length f1 and at least two parabolic mirrors 33 with a second focal length f2. The first and second focal lengths f1 and f2 preferably do not have the same values.

FIG. 5 shows an example of a compound parabolic concentrator mirror (CPC) 32. The spatially extended infrared radiation source 3, the infrared detector 9 or the ATR crystal 15 can be accommodated in a focal point 34 of the CPC 32.

In the event that the spatially extended infrared radiation source 3 is arranged in the focal point 34 of the CPC 32, the CPC is designed to collimate the light L emitted by the infrared radiation source 3.

In the event that the infrared detector 9 or the ATR crystal 15 is arranged in the focal point 34 of the CPC 32, the CPC is designed to focus the light L, incident in the direction of the infrared detector 9 or respectively the ATR crystal 15 at an angle of up to θ, preferably collimated, onto the infrared detector 9 or the ATR crystal 15.

FIG. 6a to FIG. 6c show various views of an assembly of a holder 35 for an ATR crystal 15 which can be used in the context of the invention. FIG. 6a shows an oblique top view of a top side 37 of the holder 35, i.e. the side of the holder 35 that faces a sample 17. The top side 37 of the holder 35 has an opening 39 which is configured to accommodate the ATR crystal 15 flush with the surface and to seal it tightly by means of suitable means, e.g. solder.

FIG. 6b shows a bottom side 41, i.e. a surface of the holder 35, which is opposite the top side 37. The bottom side 41 has two openings 43 and 45 which are connected to the opening 39 of the top side. The two openings 43 and 45 are separated from each other by a web 47.

FIG. 6c shows a sectional view along the sectional line AA from FIG. 6a. In FIG. 6c, an ATR crystal 15 is additionally included. The ATR crystal 15 is designed in such a way that it ends flush with the surface 37 of the holder 35 and lies on the web 47. In the holder 35, the ATR crystal 15 can be fixed in the holder 35, for example with the help of solder or adhesive. By resting the ATR crystal 15 on the web 47, the web 47 can absorb any compressive forces while pressing a sample 17 onto the ATR crystal 15. The web accordingly acts as an abutment in relation to compressive forces from the direction of the top side 37 of the holder 35 on the ATR crystal. This can prevent the ATR crystal 15 from breaking out of the holder 35.

Preferably, the holder ±is produced from metal in a 3D printing method. Preferably, the 3D printing method from metal has a print resolution per layer of a maximum 230 μm. This ensures the necessary fit of the ATR crystal in the holder.

FIG. 7a,b show two views of an exemplary mirror holder 49 in the interferometer 5a, 5b of the FTIR spectrometer 1 according to the invention. FIG. 7a shows a side view of the mirror holder 49; FIG. 7b shows a top view of the mirror holder 49.

The mirror holder 49 can have a main body 51 that is connectable to a section of the interferometer or the FTIR spectrometer, e.g. a housing section. A first part 53 is connected to the main body 51. The first part 53 has a first spring steel plate 55. The main body 51 is connected to the first part 53 by means of the first spring steel sheet 55. In this case, the first part 53 can be designed plate-like. A first screw 57 rotatably mounted in the main body 51 distances the first part 53 from the main body 51. The first screw 57 has only a force-fit connection to the first part 53. The first spring steel plate 55 exerts a spring force in such a way that the first part 53 is pretensioned in the direction of the main body 51, and the first screw 57, or respectively an end of the first screw 57 facing the first part 53, forms an abutment for the spring force of the first part 53.

The force-fit connection of the screw end of the first screw 57 can, for example, be made directly to the first part 53 or a separate material. Preferably, the separate material is abrasion-resistant and withstands the forces that the screw end of the first screw 57 exerts on the first part from the force-fit connection, in particular during frequent rotational movements. This extends the service life of the mirror holder 49.

The mirror holder also has a second part 59. The second part 59 is connected to the first part 53. The second part 59 has a second spring steel plate 61. The second part 59 is connected to the first part 53 by means of the second spring steel plate 61. A second screw 63 rotatably mounted in the first part 53 distances the second part 59 from the first part 53 and/or from the main body 51. The second screw 63 has only a force-fit connection with the second part 59. The second spring steel plate 61 exerts a spring force in such a way that the second part 59 is pretensioned in the direction of the first part 53, and the second screw 63, or an end of the second screw 63 facing the second part 59, forms an abutment for the spring force of the first part 53. A through-hole 64 in the main body 51 allows access to the second screw 63.

The second part 59 additionally comprises a mirror 65. The mirror 65 can be attached to the second part 59, comprised by the second part 59 or be formed by the second part 59. In the absence of a second part 59, the mirror 65 can also be attached to the first part 53, encompassed by the first part 53, or be formed by the first part 53.

The first and second parts 53, 59 have a cuboid shape. Moreover, the second spring steel sheet 61 is arranged on one of the side surfaces 67 of the second part 59, which is perpendicular to the surface 69 that accommodates or provides the mirror. The surface normal of the first spring steel sheet 55 is arranged perpendicular to the normal of the surface 69 and perpendicular to the normal of the surface 61, and is accommodated on a side surface 71 of the first part 53.

FIG. 8a-h show measurement results for measured parameters of a mirror 19′ of the mirror arrangement 13 of the FTIR spectrometer 1 according to the invention in comparison with commercially available mirrors.

FIG. 8a shows a metal precision mirror as used in a mirror arrangement outside the interferometer in commercial FTIR spectrometers. FIG. 8b shows a mirror 19′ of the mirror arrangement 13 of the FTIR spectrometer 1 according to the invention. The measured mirror 19′ has a main body 23 consisting of PMMA plastic and was produced by injection molding. Then the reflecting surface was applied as a metallic coating consisting of gold.

FIGS. 8c and 8d show measurement data of the reflecting surfaces 21 of the mirrors shown in FIGS. 8a and 8b in the form of the measured height in along the path along the arrow A. The shown measurement data were taken with a profilometer known in the prior art. The shown measurement data clearly reveal a parabolic shape of the profile.

FIG. 8e and FIG. 8f each show two measurement results of the microscopic surface roughness of the metal precision mirror from FIG. 8a. FIG. 8g and FIG. 8h each show two measurement results of the surface roughness of the mirror 19′ of the mirror arrangement 13 of the FTIR spectrometer 1 according to the invention from FIG. 8b. The average roughness in the case of FIG. 8e and FIG. 8f is 17.8 nm RMS (root mean square) and 14.5 nm RMS; the average roughness in the case of FIG. 8g and FIG. 8h is 39.1 nm RMS and 17.3 nm RMS. Surprisingly, the microscopic surface roughness of the mirror in FIG. 8b is in the order of magnitude of the roughness of the metal precision mirror in FIG. 8a and is only about a factor of two larger and accordingly much below the shortest wavelength of approx. 1 μm used in FTIR spectrometers.

FIG. 9a shows an assembly 73 of an exemplary beam path used in the context of a simulation in the FTIR spectrometer 1 according to the invention. The shown assembly 73 basically corresponds to the beam path from FIG. 2a,b up to the ATR crystal 15. The assembly 73 comprises a circular infrared radiation source 3′ with a diameter of 2 mm assumed for the simulation. In addition, a parabola 75 with a defined phase error is provided, in which the light from the infrared radiation source 3′ is collimated. In the simulated assembly 73, the aperture 77 of a beam splitter in the interferometer is taken into account. The assembly 73 also comprises a second, focusing parabola 79 as well as the apertures of the ATR crystal and the holder of the ATR crystal.

In the simulation, the parabola 75 collimates the light from the infrared radiation source 3′. In so doing in the simulation, a phase error of the parabola 75 is introduced via Zernike polynomials known in the prior art. By the introduction of phase errors on the first parabola 75 by means of Zernike polynomials, the transmission can be influenced by the assembly. The power transmitted in the simulated assembly 73 is 10% of the power emitted by the infrared radiation source 3′.

FIG. 9b shows the result of the simulation in the form of multiple curves that represent transmission through the optical system depending on the deviation from an ideal parabolic shape. Each dashed curve is assigned to a different Zernike polynomial. In addition, the mean value of all shown curves is represented as a solid line. The three insets in FIG. 9b are 2D interferograms of the beam propagated through the system with an unmodified reference beam. They show the influence of the introduced phase error. Depending on the type of introduced phase error (linear left/right or spherical), the transmission through the simulated system can be increased or decreased. For a wavelength of λ=2 μm and a randomly oriented phase error (average of all curves in FIG. 9b), a wavefront error of approximately 300 μ, i.e. 300 times the wavelength, is tolerable without reducing the efficiency of the optical system. Surprisingly, therefore, the use of mirrors whose main bodies have plastic or consist of plastic and, in particular, the use of economical injection-molded optical systems of plastic, which can introduce wavefront errors up to the aforementioned level, is generally unproblematic.

FIG. 10a shows two exemplary single-shot FTIR spectra, each of which was recorded with an FTIR spectrometer 1 according to the invention based on the mirror arrangement according to the invention with injection-molded mirrors and a spectrometer based on a similar mirror arrangement with precision metal mirrors. In so doing, the individual spectrum I was recorded with the FTIR spectrometer 1 according to the invention. The single spectrum C was recorded with the same spectrometer using commercial precision metal mirrors.

The shown spectra were not averaged. The employed FTIR spectrometer 1 according to the invention comprised exclusively mirrors 19 in the mirror arrangement 13 whose main bodies 23 comprised a plastic material and which were produced by means of an injection molding method.

FIG. 10b shows the calculated difference spectrum D of the spectra C, I shown in FIG. 10a. FIG. 10b shows only minimal difference values between the spectra at various wavenumbers. Deviations are basically due to a slightly different adjustment of the two employed FTIR spectrometers.

FIG. 11 shows various spatially resolved measurements of wavefront errors of the central part of metal precision mirrors and various embodiments of mirrors according to the invention. The measurements were carried out using a Shack-Hartmann wavefront sensor with a collimated laser beam at a wavelength of 556 nm. The mirrors used for the measurements in FIG. 11 each had a parabolic shape.

The spatial position of the reflecting surface (x and y position) of the mirror as well as the measured wavefront error (coded as gray levels) are shown in the subfigures of FIG. 11. The peak to valley (PV) value above each subfigure describes the maximum measured wavefront error (difference between the highest and lowest point in the wavefront profile) on the employed surface of the employed mirror. The root mean square (RMS) value above each subfigure describes the root mean square value of the wavefront error on the displayed surface of the employed mirror.

FIGS. 11a and 11b show measurements of the spatially resolved wavefront error of two different metal precision mirrors (Metallic-1 and Metallic-2). FIG. 11c to 11h show measurements of the spatially resolved wavefront error of embodiments of a mirror of the mirror arrangement outside the interferometer of the FTIR spectrometer according to the invention. For the measurement in FIGS. 11c and 11d, two different mirrors consisting of polymethyl methacrylate (PMMA-1 and PMMA-2) were used. For the measurement in FIGS. 11e and 11f, two different mirrors (PU-1 and PU-2) consisting of polyurethane were used. Two different mirrors (PC-1 and PC-2) consisting of polycarbonate were used for the measurements in FIGS. 11g and 11h.

The measurements in FIG. 11c to 11h show an absolute wavefront error of up to 5 μm (PV), i.e. a multiple of the reference wavelength of 2 μm. As already described above, these mirrors would not be suitable for use in an interferometer of an FTIR spectrometer. However surprisingly, all of the shown mirrors could be used to measure samples in the FTIR spectrometer according to the invention.

1. An FTIR spectrometer comprising:
an infrared radiation source,
an interferometer with at least one arm variable in length,
a reference laser,
a measuring cell with a sample interface, preferably an ATR crystal which can be brought into contact with a sample ,
an infrared detector ,
a control system which is configured to change the length of the at least one arm of the interferometer , and
a mirror arrangement outside the interferometer with at least two mirrors, each with a reflecting surface and a main body that comprises the reflecting surface, wherein the mirror arrangement is at least configured to direct a light beam from the interferometer onto the sample interface and to direct the light beam from the sample interface onto the infrared detector,
wherein the main body of at least one mirror or all mirrors of the mirror arrangement is or respectively are made of a plastic material and/or of 3D printed metal, or the main body of at least one mirror or of all mirrors has or have plastic material and/or 3D printed metal.

2. The FTIR spectrometer according to claim 1, wherein at least one mirror of the mirror arrangement outside the interferometer has a mirror shape or a combination of mirror shapes from the following list: an off-axis parabolic mirror, a parabolic mirror, a compound parabolic concentrator, a spherical concave mirror, a mirror that has at least in one axis the shape of at least one parabolic segment or a circular segment.

3. The FTIR spectrometer according to claim 1, wherein each mirror of the mirror arrangement outside the interferometer has a mirror shape or a combination of mirror shapes from the following list: an off-axis parabolic mirror, a parabolic mirror, a compound parabolic concentrator, a spherical concave mirror, a mirror that has at least in one axis the shape of at least one parabolic segment or a circular segment.

4. The FTIR spectrometer according to claim 1, wherein at least one of the mirrors of the mirror arrangement whose main body is made of a plastic material or has a plastic material, is produced by an injection molding process or a 3D printing method, and the reflecting surface is at least partially formed by a metal coating.

5. The FTIR spectrometer according to claim 1, wherein the plastic material is at least one material from the following list or has at least one material from the following list: Polymethyl methacrylate (PMMA), polycarbonate (PC), cycloolefin polymer, cycloolefin copolymer, styrene acrylonitrile, styrene acrylonitrile, polycarbonate high temperature, polysulfone (PS), polyamide (PA), polycarbonate high refractive, polyester high refractive, polyethylene terephthalate (PET), polyethylene terephthalate with glycol (PETG), acrylonitrile-butadiene-styrene copolymer (ABS), nylon, polylactic acid (PLA), polyurethane (PU), a light-curing plastic (photopolymer), for example acrylic, epoxy and/or vinyl ester resin.

6. The FTIR spectrometer according to claim 1, wherein the reflecting surface of at least one mirror of the mirror arrangement at least regionally has a free-form optical system.

7. The FTIR spectrometer according to claim 6, wherein the free-form optical system has at least regionally a shape deviation from one of the following mirror shapes: an off-axis parabolic mirror, a parabolic mirror, a compound parabolic concentrator, a spherical concave mirror, a mirror that has at least in one axis the shape of at least one parabolic segment or a circular segment.

8. The FTIR spectrometer according to claim 7, wherein the free-form optical system has at least regionally a shape deviation in an edge region.

9. The FTIR spectrometer according to claim 8, wherein the shape deviation is a convex regular or irregular rounding or chamfer or a combination of a convex regular or irregular rounding and/or a chamfer.

10. The FTIR spectrometer according to claim 1, wherein at least one mirror of the mirror arrangement or each mirror of the mirror arrangement is designed and configured in such a way that upon the reflection of infrared light at the particular mirror of the mirror arrangement, the infrared light has a maximum wavefront error per mirror of 50 times the wavelength, preferably 25 times the wavelength of the infrared light.

11. The FTIR spectrometer according to claim 1, wherein the mirrors of the mirror arrangement and of the interferometer are designed and configured in such a way that, upon the reflection of infrared light at the mirrors of the mirror arrangement, the infrared light has a total maximum wavefront error from the infrared radiation source to the infrared detector of 300 times the wavelength of the infrared light.

12. The FTIR spectrometer according to claim 1, wherein the mirror arrangement comprises at least two off-axis parabolic mirrors having a first focal length and at least two parabolic mirrors having a second focal length.

13. The FTIR spectrometer according to claim 1, wherein the sample interface is an ATR crystal that is accommodated in a holder, wherein the holder is produced from metal in a 3D printing method.

14. The FTIR spectrometer according to claim 1, wherein the holder is configured to hold the ATR crystal stationary at a contact pressure of the sample of up to 130 web on the ATR crystal.

15. The FTIR spectrometer according to claim 1, wherein the ATR crystal has a maximum sample support surface of at most 3 mm by 3 mm.
